(19) United States
(12) Patent Application Publication
(10) Pub. No.: US 2002/0160773 A1
(43) Pub. Date: Oct. 31, 2002

(54) Communications systems for aircraft including wireless systems

(75) Inventors: Simon I. Gresham, Seattle, WA (US); Peter W. Lemme, Kirkland, WA (US); Brendan K. Reville, Seattle, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Tenzing Communications, Inc., Seattle, WA

(21) Appl. No.: 10/112,611

(22) Filed: Mar. 28, 2002

Related U.S. Application Data
(60) Provisional application No. 60/280,318, filed on Mar. 29, 2001.
(60) Provisional application No. 60/280,446, filed on Mar. 29, 2001.

(51) Int. Cl. H04Q 7/20

(52) U.S. Cl. 455/431; 455/412

(57) ABSTRACT

A system for permitting passengers on board an aircraft to send and receive electronic data is described. The components of the system on board the aircraft include a server having a plurality of nodes to which computer terminals are attached, as desired. The components of the system on board the aircraft include a wireless access point having a plurality nodes, where the wireless access point is attached to the server and to a plurality of wireless cards inserted into computer terminals, as desired. The computer terminals are laptop or palm-top personal computers belonging to the various passengers on board or fixed terminals within the aircraft. The server communicates with a wide variety of different terminals running different operating systems and with the access point. Each computer terminal is connected to the server via an aircraft cable or wireless network. Server has mass storage which contains a database of WWW pages which can be browsed by passengers using terminals. Server provides a domain name server (DNS) that masquerades as the passenger's usual DNS. Server then links the passenger to the appropriate locally stored WWW page. Server also contains storage for e-mail messages. Connected to server is one or more radios. This permits data to be transferred to base station using communications network. A virtual private network (VPN) connects station to communications service provider networks, web content processor, and via links to the Internet, including access to subscriber ISPs/corporate mail servers and other mail servers. Points of Presence (POP) provide Internet access and e-mail service to subscribers of the service while not on the aircraft. POPs can also be used by communications service provider networks and web content processors as an alternate means to connect to VPN.

### BACKGROUND OF THE INVENTION

1. Field of the Invention

The present invention relates generally to a communication system for mobile data services, and, more particularly, to a system and method for wireless Internet services with passenger aircraft and will be described hereinafter with reference to that application. However, it will be appreciated that the invention is not limited to that particular field of use.

2. Description of the Related Art

Since the 1980s, mobile data services have been hosted on portable computers such as “laptop” PCs, personal digital assistants (PDAs) running Palm OS or Microsoft® Windows CE, and cellular telephones and pagers. There have been commensurate improvements in mobile wireless (a.k.a. cellular) communications (Wide Area Network, WAN) technology such as the GSM (Global System for Mobile Communications), with emerging data services such as GPRS (General Packet Radio Service), and applications such as WAP (Wireless Application Protocol) and SMS (Short Message Service), CDPD (Cellular Digital Packet Data), and a variety of proprietary services, (e.g., Mobitex). Local Area Network technology such as IEEE 802.11b, are available at costs approaching wired networks. IR and Bluetooth have become promising Personal Area Networks, for example to link a laptop or PDA to the Internet via a cellular telephone running GSM/GPRS.

E-mail messages and other electronic data can now be sent and received by an individual at one of many locations, without the need to connect via a fixed land telephone line or other wired data network. Some operators have joined together to provide seamless roaming through their networks (e.g., GSM). A user forms a relationship with one provider (home) and is given service through many providers (visited).

In parallel to emerging technology trends are concerns over control of sensitive data, including messaging. Before giving access, the user should be authenticated and sensitive data should be encrypted by the end users.

Traditional techniques, such as simply connecting a remote user to the corporate network through a VPN do not scale to narrowband cellular technology. Alternative technologies include the use of XML (Extensible Markup Language) to request only the needed data objects in a well known format using an efficient file transfer method.

Many users want access to corporate messaging, calendar, contacts, and files, through a session-based “generic” interface. A session uses a generic interface wherein the user logs in with an identification and password. This technology must be matched to the communications service, including bandwidth of the network, processing capacity of the terminal, display and interface capability of the user terminal. WAP is an example of a method of implementing a generic interface to administer a session. The user points the browser to the corporate access site and provides username and password. The user is then provided a dynamically generated page listing messages or other user information in an interactive manner.

Several communications networks for providing telecommunications to airborne users are known. For example, the North American Telephone System (NATS), including providers such as AT&T and Airfone, have installed terminals in many commercial aircraft to allow passengers to connect a laptop or PDA and transfer data from the passenger's seat. Non-traditional communication networks, such as GSM, GPRS, CDPD, and proprietary networks can be used to connect a server installed on the airplane to the base station, while the airplane is on the ground.

In addition to terrestrial based aeronautical communications, satellite service providers, such as Inmarsat, provide airborne passengers communications from virtually any global location. Furthermore, other satellite providers have or are launching constellations of satellites with the intention of providing airborne passenger communications.

Existing aeronautical passenger communications are generally slow and expensive in comparison to equivalent land mobile services. In most cases, the passenger connects the laptop or PDA to a seat mounted handset using an integrated RJ11 jack. The passenger must make a modem connection to their ground-based access server, provide authentication information, and then retrieve or send data. This process is generally technically challenging and unreliable. Even for the transfer of small amounts of data, one or more calls of one or more minutes are often necessary. The existing speed of transmission, defined as bits per second (bps), is relatively slow—for example, the INMARSAT satellite services currently limit the data rate for passenger modem communications to 2400 bps. Satellite communications introduce additional latency, as much as several seconds, which can increase the transfer times. The time taken to transfer large amounts of electronic data, and the consequential expense, are generally prohibitive to most passengers.

Thus, until now, mobile data communication services, such as sending and receiving electronic mail and browsing World Wide Web (WWW) sites, has not been deemed feasible while on an aircraft or other “remote” location.

### SUMMARY OF THE INVENTION

The present invention is embodied in a system and method for electronic communication on board an aircraft and, in one embodiment, comprises a system to permit electronic communication between a passenger electronic messaging device operated by a passenger and a ground-based electronic messaging system. In this embodiment, the system comprises and airborne computing system and an access point positioned aboard the aircraft and coupled to the airborne computing system to permit communication with the passenger messaging device and thereby form a computer network. A proxy server is coupled to the computer network to emulate the response of the ground-based electronic messaging system with respect to the passenger messaging device whereby the passenger messaging device interacts with the proxy server in a manner consistent with the direction between the passenger messaging device and the ground-based electronic messaging system when the passenger messaging device is not on the aircraft.

In one embodiment, the passenger messaging devices may include, by way of example, a personal computer, a personal digital assistant (PDA), paging device and wireless telephone. In an alternative embodiment, the airline may supply built-in terminals and, in this embodiment, the airline supplied computing device installed on the aircraft is the passenger messaging device and exchanges passenger messages with the ground-based electronic messaging system.

The proxy server receives and transmits to the ground-based electronic messaging system mail server addresses, user IDs, and passwords, including firewall access information when the passenger initially attempts to send or retrieve messages. Alternatively, the passenger may provide the information regarding the ground-based electronic messaging system to a ground-based computer system prior to a flight. In this embodiment, the proxy server establishes a communication link with the ground-based computer system to retrieve the passenger identification information. In one embodiment, the proxy server establishes a communication link with the ground-based electronic messaging system prior to flight departure to retrieve messages from the ground-based electronic messaging system intended for the passenger. In this embodiment, the communication link with the ground-based electronic messaging system may be established using a public wireless data network.

In another embodiment, the system further comprises a base station to communicate with the aircraft while in flight. The base station is communicatively coupled to a ground-based proxy server to communicate with the ground-based electronic messaging system. The ground-based proxy server emulating the response of the passenger messaging device with respect to the ground-based electronic messaging system whereby the based-based electronic messaging system interacts with the ground-based proxy server in a manner consistent with the interaction between the passenger messaging device and the ground-based electronic messaging system when the passenger messaging device is not on the aircraft.

The proxy server may establish a communication link with the ground-based electronic messaging system via the ground-based proxy server to retrieve messages from the ground-based electronic messaging system intended for the passenger and to transmit messages from the passenger. In an exemplary embodiment, the proxy server may periodically establish a communication link with the ground-based electronic messaging system via the ground-based proxy server after the initial retrieval to automatically check for messages intended for the passenger without any additional requests for message retrieval from the passenger.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to.”

### BRIEF DESCRIPTION OF THE DRAWINGS

Various embodiments of the invention will now be described, by way of example only, with reference to the accompanying drawings.

FIG. 1 is a schematic overview of a system according to the present invention.

FIG. 2 is a schematic sectional view of a part of an aircraft.

FIG. 3 is a schematic view of the installation of a wireless adaptor in one portion of an aircraft.

FIG. 4 is a schematic sectional view illustrating the installation of a wireless adaptor in an alternative location in the aircraft.

FIG. 5 is a block diagram of an aircraft network according to another aspect of the invention.

FIG. 6 is a block diagram of an alternative aircraft network according to the invention.

FIG. 7 is a block diagram of a further alternative aircraft network according to the invention.

FIG. 8 is a block diagram of a further alternative aircraft network according to the invention.

FIG. 9 is a flow diagram illustrating the protocols for transferring email or other data to the aircraft.

FIG. 10 is a flow diagram illustrating an alternative protocol for transferring e-mail or other data to the aircraft.

FIG. 11 is a flow diagram illustrating a further alternative protocol for transferring e-mail or other data to the aircraft.

FIG. 12 is a flow diagram illustrating a further alternative protocol for transferring e-mail or other data to the aircraft.

FIG. 13 is a flow diagram illustrating the protocols for transferring e-mail or other data from the aircraft.

FIG. 14 is a flow diagram illustrating an alternative protocol for transferring e-mail or other data from the aircraft.

FIG. 15 is a flow diagram illustrating a further alternative protocol for transferring e-mail or other data from the aircraft.

FIG. 16 is a flow diagram illustrating a further alternative protocol for transferring e-mail or other data from the aircraft.

FIG. 17 is a schematic representation of the interaction of an aircraft and the terrestrial part of the system of FIG. 1 as it travels from a point of departure to a destination.

### DETAILED DESCRIPTION OF THE INVENTION

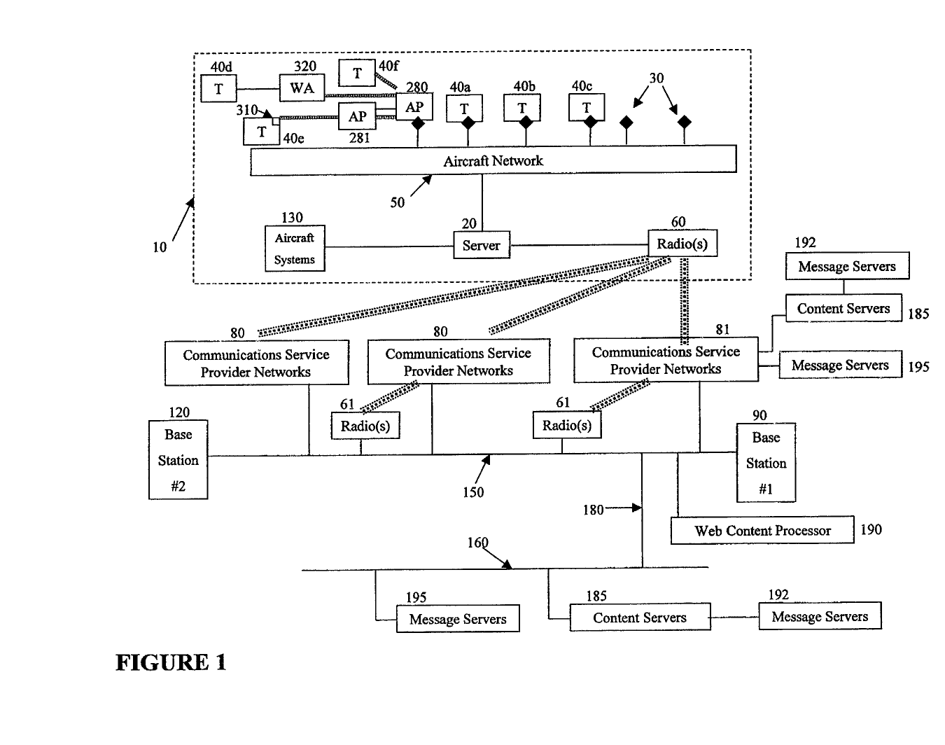

Referring to FIG. 1, a system for permitting passengers on board an aircraft to send and receive electronic data is shown. Those parts of the system located on board the aircraft are shown within the region bounded by broken lines and labeled 10 in FIG. 1. The components of the system on board the aircraft include a server 20 having a plurality of nodes 30 to which terminals 40a, 40b and 40c are attached, as desired. The terminals in the embodiment shown are laptop or palm-top personal computers, or wireless access devices such as cell phones and pagers, belonging to the various passengers on board. As will be explained below, the server communicates with a wide variety of different terminals running different operating systems. Each node 30 is connected to the server 20 via an aircraft network 50.

Referring to FIG. 1, the components of the system on board the aircraft include an access point AP 280 connected via the airplane network 50 to server 20. Additional access points AP 280, may be added to increase coverage in the airplane cabin or to accommodate different protocols or radios. The access points AP 280 may alternatively connect through each other to a single physical connection to airplane network 50. The access points AP 281 may connect to each other using wired or wireless networks.

The components of the system on board the aircraft include a plurality of terminals 40d, 40e, and 40f, with wireless connections to access point AP 280 and AP 281. The AP 280 and AP 281 allow the server 20 to communicate wirelessly with the computer terminals 40d, 40e, and 40f. Terminal 40d is connected to wireless adaptor WA 320 using a wired network such as Universal Serial Bus (USB). Wireless Adaptor WA 320 may be physically powered by Terminal 40d USB. Wireless Adaptor 320 provides a connection between Terminal 40d and access point AP 280. Terminal 40e includes a wireless card 310, such as the Nokia C110 Wireless LAN Card, which provides a wireless connection to access point AP 281. Terminal 40f is a wireless device, such as a cell phone wireless messaging device or pager, and is connected to access point AP 280.

The server 20 has mass storage which contains a database of WWW pages which can be browsed by passengers using their computer terminals 40a, 40b, 40c, 40d, 40e, and 40f. Server 20 provides a domain name server (DNS) that masquerades as the passenger's usual DNS. Server 20 then links the passenger to the appropriate locally generated WWW page. The server 20 also contains storage for messages, such as e-mail. Those skilled in the art will appreciate that the system may include one or more servers 20. Furthermore, the server 20 may be implemented on a single computing platform, or multiple distributed computing platforms, which are well known in the art and need not be described in greater detail herein.

Connected to the server 20 are one or more radios 60. This permits data to be exchanged with base station 90 or base station 120, using one or more communications networks 80 or 81.

A virtual private network (VPN) 150 connects base station 90 and base station 120 to communications service provider networks 80 and 81 via wireless connections via radios 61 or other wired Internet networks. The VPN 150 also provides connections to web content processor 190, and via links 180 to the Internet 160.

Base station 90 and base station 120 use the Internet 160 to connect to Internet service provider (ISP) or corporate message servers 195 or content servers 185 which host the servers of the respective passengers on board the aircraft who are connected to server 20.

Base station 90 and base station 120 connect through communications service provider networks 81 to service provider or corporate message servers 195 or content servers 185 which host the servers of the respective passengers on board the aircraft who are connected to server 20 and use those provided networks.

Connections to content servers 185 provide a private connection to protected message servers 192 which host the servers of the respective passengers on board the aircraft who are connected to server 20 and use those provided networks.

The operating system of the preferred server also continually monitors all of the primary services provided by the server. If errors occur then the system automatically re-boots. However, remote diagnosis of faults on the server is also possible using the communications link with the base station 90. SNMP (Simple Network Management Protocol) is used for network monitoring.

Electronic messages sent from various terminals 40 (40a, 40b, 40c, 40d, 40e, 40f) on board the aircraft are first forwarded to server 20 where they are stored. The server 20 determines the appropriate time to initiate a data exchange with station 90. This can be when sufficient data is awaiting transmission from server 20, or when the time since the last exchange exceeds a time limit (e.g., 15 minutes), or when station 90 signals to server 20 via communications service provider network 80 or 81 and radio 60. Any messages stored on server 20 since the previous connection was made are then transmitted to station 90. Station 90 forwards each message on to their eventual destination message servers 195 or message servers 192.

The general procedure for obtaining messages from the Internet service providers or corporate accounts of the various passengers is similar to the procedure for sending messages from the terminal 40 on the aircraft. Once a passenger connects a terminal 40 to aircraft network 50 and then connects to server 20, the passenger initiates proxy message retrieval. Server 20 accepts the request for messages and collects the passenger message server address, user id and password. If necessary, a corporate subscriber can activate previously setup firewall services, and provide additional username and password information. This information is passed to base station 90 via radio 60 and communications service provider networks 80 or 81. Base station 90 contacts message servers 195 and content servers 185 and collects any messages for the passengers using their user IDs and passwords. Base station 90 continues to collect messages for the duration of the flight that the passengers are on. When a connection is established between server 20 on board the aircraft and station 90, that stored message or messages are transmitted from station 90 to server 20. This procedure is usually simultaneous with the transmission of messages in the other direction from server 20 to station 90.

Messages can be retrieved in a manner that preserves their original (native) presentation and features, such that they are indistinguishable from messages retrieved while on the ground. In another configuration, the messages are retrieved in a manner such that only the pertinent message text is retained along with the message header information (e.g. To:, From:, Subject; Time). This text messaging service is inherently lower cost to transmit, since the text messages are substantially smaller than their original, native form.

Once messages have been received at server 20, they are retrieved by the respective passenger's terminal 40 via the aircraft network 50 when the passenger subsequently connects to server 20 and retrieves messages.

In one embodiment, station 90 signals server 20 with a trigger signal which indicates that data in the form of messages is stored by the station and awaits retrieval. The server 20 then signals the message data, such as from and subject, as well as size and cost to retrieve, to the passenger via terminal 40. The passenger provides a signal from terminal 40 to server 20 indicating which messages or parts of messages are approved to be retrieved. The passenger may optionally preauthorize messages below a configured size. The server 20 then establishes a communication link with the base station 90 to retrieve the authorized data, which is then transmitted to the server 20 and retrieved by terminal 40.

In a further embodiment, data is transmitted from server 20 to base station 90 at intervals based on predetermined periods of time that the aircraft has been in flight.

Similarly, any messages generated by the user of terminal 40 are also sent to server 20 for storage, and forwarded to station 90 along with the stored messages from the other passengers. The station 90 then forwards messages from the computer terminal 40 on to their eventual destinations as well.

While this disclosure describes electronic messages or web pages as being sent from servers to computer, servers usually retain the electronic message and web pages, and allow the electronic message and web browser client applications (which may reside on the computer terminal or on the same server) to fetch a copy of, or view, the electronic mail or web pages. The electronic mail and web browser client applications allow the user to view the data (which is typically stored on the server, not on the computer terminal) using the computer terminal.

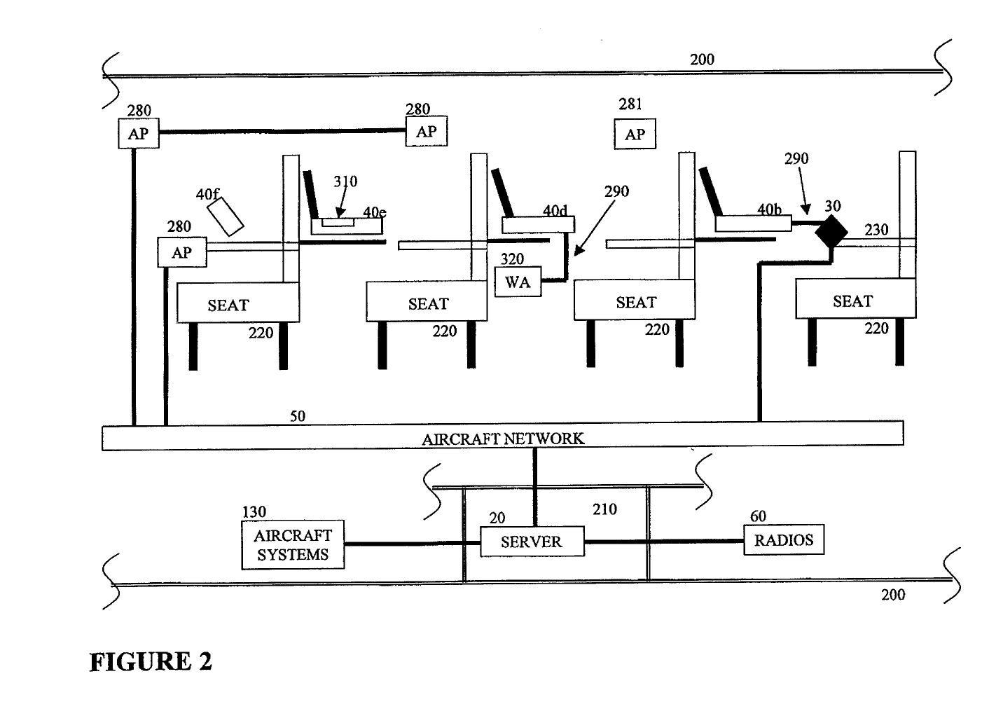

Referring to FIG. 2, a section through an aircraft fuselage is shown schematically at 200. Features common to FIGS. 1 and 2 are labeled with like reference numerals.

The part of the system on board the aircraft comprises server 20, mounted within a hold 210 of the aircraft. In other embodiments server 20 is mounted elsewhere within the aircraft. As described in connection with FIG. 1, the server 20 is connected to the aircraft network 50, to the aircraft systems 130, and is connected to radios 60. The system on board the aircraft may include AP 280, AP 281 and nodes 30, connected to server 20 by aircraft network 50.

Aircraft network 50 provides a set of connection points 30 that provide a means to communicate between server 20 and each passenger terminal 40. A typical terminal may have one or more of the following interfaces available:

1. Telephone Modem

2. RS-232 Serial Port

3. Universal Serial Bus (USB)

4. IEEE 1394

5. 802.3 Ethernet

6. 802.11 Wireless Ethernet

7. Bluetooth

8. Cellular Wireless, such as GPRS

9. Proprietary Wireless

10. Proprietary Wired

11.IR

The aircraft network 50 may support one or more of the above interfaces.

Referring to FIG. 2, terminal 40b is connected via cable 290 to node 30 in arm rest 230. Cable 290 may connect a telephone modem in terminal 40b to a handset in seat 220. In an alternative configuration, cable 290 may connect to node 30 using RS-232, USB, IEEE 1394, or 802.3 Ethernet.

Returning again to FIG. 2, terminal 40d is connected to wireless adaptor 320 using cable 290. Wireless adaptor 320 is connected to aircraft network 50 via access points AP 280 or AP281. Cable 290 may connect to WA 320 using USB, or alternatively RS-232, IEEE 1394 or 802.3 Ethernet. WA 320 may be powered entirely from terminal 40d when using cable 290. The WA 320 may be an off-the-shelf commercial product.

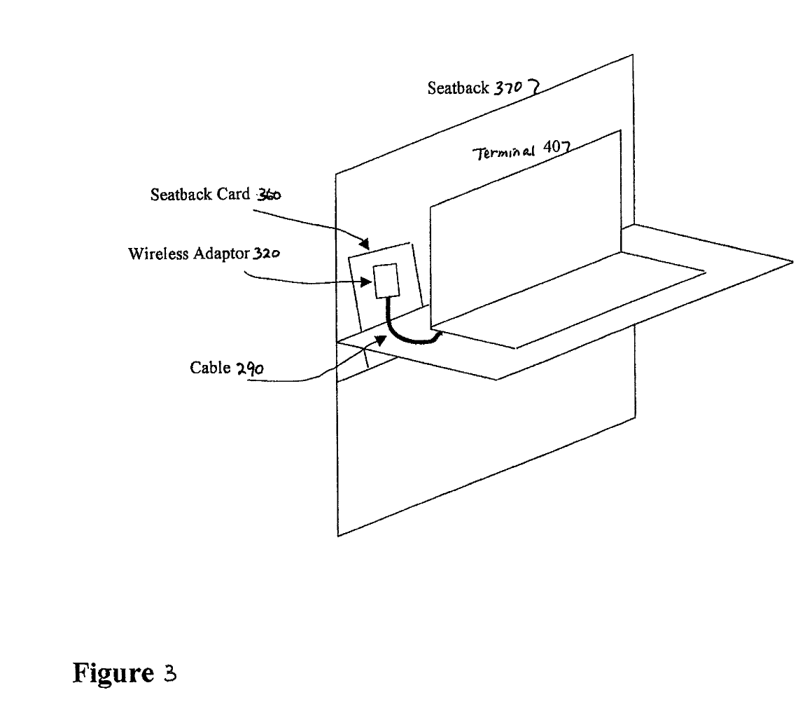

The WA 320 may be mounted on a seat back card 360 which may be mounted, by way of example, in a seat back 370 of the seat 220, as illustrated in FIG. 3. A number of advantages are provided by this implementation with the wireless system. First, the wireless adaptor 320 may be specially qualified to be safely used on board the aircraft. This ensures compatibility between the terminal 40 and other electronic systems (not shown) on board the aircraft, such as radar, communications, navigational equipment, and the like. Second, the WA 320 allows access to the server 20 without requiring an internal wireless board in the terminal 40. In this implementation, the terminal 40 is coupled to the WA 320 using the cable 290. In one implementation, the cable 290 may be a USB cable coupled to a conventional USB interface (not shown) on the terminal 40. Other well-known interface types, such as RS-232, IEEE 1394, Ethernet, or the like may also be used within the terminal 40. The wireless adaptor 320 may be configured to have the appropriate connector for the selected interface type.

Another advantage provided by the implementation of FIG. 3 is that the WA 320 is not wired to the aircraft in any manner. That is, the WA 320 is mounted to the seat back card 360. In one configuration, it is not wired to the aircraft and it does not derive power from the aircraft. Since no wires or power are required from the aircraft, installation of the WA 320 on the seat back card 360 allows airlines to install the system with a relatively low cost and no additional weight for cables that would otherwise be required. In addition, no retrofitting of the aircraft is required to provide the necessary communication lines and power lines.

Finally, because the WA 320 does not derive power from the aircraft, aircraft fuel efficiency may be enhanced by eliminating the need for powering the various electronic interfaces. In a typical implementation, the WA 320 derives power from the terminal 40 via the cable 290. In contrast, a wired system that derives power from the aircraft would draw some amount of power even if no terminal 40 were coupled to the wireless adapter.

In an alternative implementation of the system illustrated in FIG. 3, the WA 320 may be a multi input port adaptor In this implementation, a single WA 320 may be provided for a plurality of passengers. For example, an aircraft may have three seats in a row on each side of a central aisleway. Rather than provide an individual WA 320 for each seat 220, the center seat on each side of the aisle may have a multi-port WA 320, which has three connectors to permit access to multiple passengers within that row.

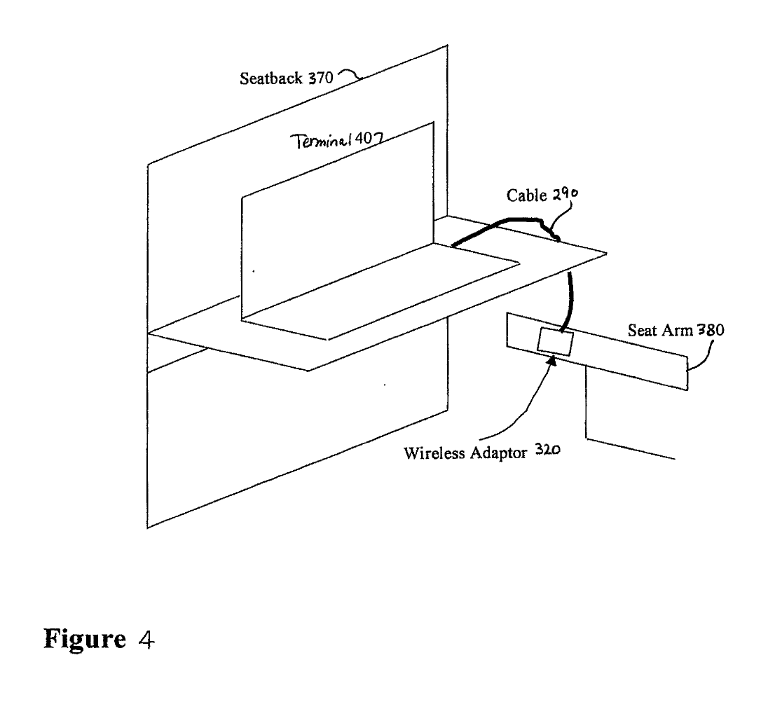

In another alternative embodiment, illustrated in FIG. 4, the WA 320 may be mounted in a seat arm 380 rather than in the seat back 370. As with the embodiments discussed with respect to FIG. 3, the cable 290 couples the terminal 40 to the WA 320 located in the seat arm 380. In a typical embodiment, the power is provided to the WA 320 from the terminal 40 via the cable 290.

Those skilled in the art will appreciate that other possible locations for the WA 320 are also possible. The aircraft may locate the WA 320 in the seat back 370, as illustrated in FIG. 3, in the seat arm 380, as illustrated in FIG. 4, or a combination of the two based on the location of the particular seats within the aircraft. For example, bulkhead seats may use the implementation illustrated in FIG. 4, while other seats may use the seat back implementation of FIG. 3. Other convenient locations may also be used to mount the WA 320.

In yet another alternative embodiment, the WA 320 may be enclosed within a protective housing and handed out by a flight attendant in a manner similar to that in which headphones are distributed for in-flight movies. In this embodiment, the WA 320 is simply a box attached to the terminal 40 via the cable 290. The protective enclosure may be conveniently stored in the seatback pouch during the flight and returned to the flight attendant at the end of the flight. As with other embodiments discussed with respect to the WA 320, the box containing the WA 320 does not derive power from the aircraft itself, but from the terminal 40 via the cable 290, as discussed above. To accommodate regulatory concerns, it may be necessary or convenient to change the protective enclosure. The data may be exchanged between the ISP or corporate mail server and the base station using one or more of: SSL, SMTP; HTTP; POP3; IMAP, WAP, XML.

Returning again to FIG. 2, terminal 40e includes a wireless card 310, which provides a wireless connection to aircraft network 50 via AP 280 or AP 281. In some cases, the passenger may be given a card 310 for use during the flight. The card 310 may be a type that is well known to be compatible and safe to use on the aircraft.

Referring to FIG. 2, terminal 40f has internal wireless interfaces and is connected to AP 280 installed in seat 220. AP 280 installed in seat 220 is connected directly to aircraft network 50. This wireless device may include a cell phone, wirelessly enabled PDA, or two-way pager. In some cases, the passenger may be given a terminal 40f for use during the flight. In that case, the terminal 40f may be a type that is well known to be compatible and safe to use on the aircraft.

In some cases, the terminal will be built into the seat itself. In this case, it generally will provide Internet and messaging functionality and is connected to server 20 via a wired connection to aircraft network 50. Typically the built-in terminal provides other functions, such as for display of movies, flight information, shopping, and gaming.

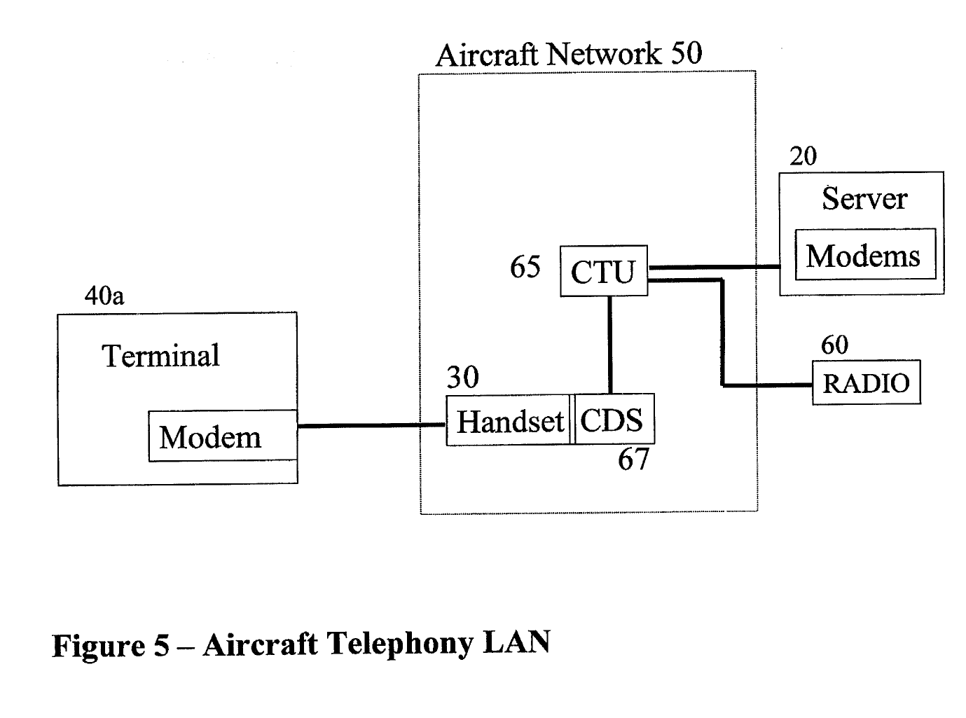

More particularly, FIG. 5 illustrates a telephone modem network interface that allows the passenger to connect their terminal 40a modem to a telephone 30 mounted such that access is available from their seat.

Airborne telephone networks generally follow the guidance of ARINC 746, “Cabin Communications Systems,” and ARINC 628, “Cabin Equipment Interfaces.”

A Cabin Telecommunications Unit (CTU) 65 provides a telephone switching capability between the Cabin Distribution System (CDS) 67 (which provides the telephones 30 in the cabin) and the radios 60 that provide air ground telephone service. The interface from the CDS 67 to the CTU 65 is described in ARINC 746, attachment 17, although many configurations are not completely compliant with this definition. The interface from the CTU 65 to the air ground radios 60 is described in ARINC 746, attachment 11. Most CTUs and radios comply with this specification, and are interchangeable.

Network 50 provides an interface to the CTU 65 such that server 20 appears to be an air ground radio 60 or a part of the CDS 67 to the CTU 65. The CTU 65 routes calls to server 20 in a manner identical to the way the CTU 65 routes telephone calls to the other air ground radios 60 or between seats 220. Server 20 uses another standard protocol, such as EuroISDN, as an alternate to ARINC 746, attachment 11 or 17. In an alternative configuration, server 20 is connected to CTU 65 using a non-standard protocol. This same interface may be used both to receive and terminate passenger data calls from their seat, as well as for interfacing to air-ground radio 60 for communicating with station 90.

The handset 30 generally provides an RJ11 jack to provide a two wire interface to the passenger terminal 40a modem. The passenger configures their PPP dial up networking to call a special phone number allocated for this service. The passenger connects their terminal 40a to the telephone handset 30 and initiates the telephone call. The CTU 65 routes this call request to server 20 based on the phone number that is being dialed by the passenger terminal 40a (and does not route the call to the air ground radios 60). In an alternative configuration, an RJ11 data jack is provided at the seat without a handset.

The server 20 terminates each call request into an internal modem bank. This allows the passenger modem and the server modem to communicate at data rates as high as 56 kbps using an existing cabin telephone system, given minimal configuration changes to the CTU 65.

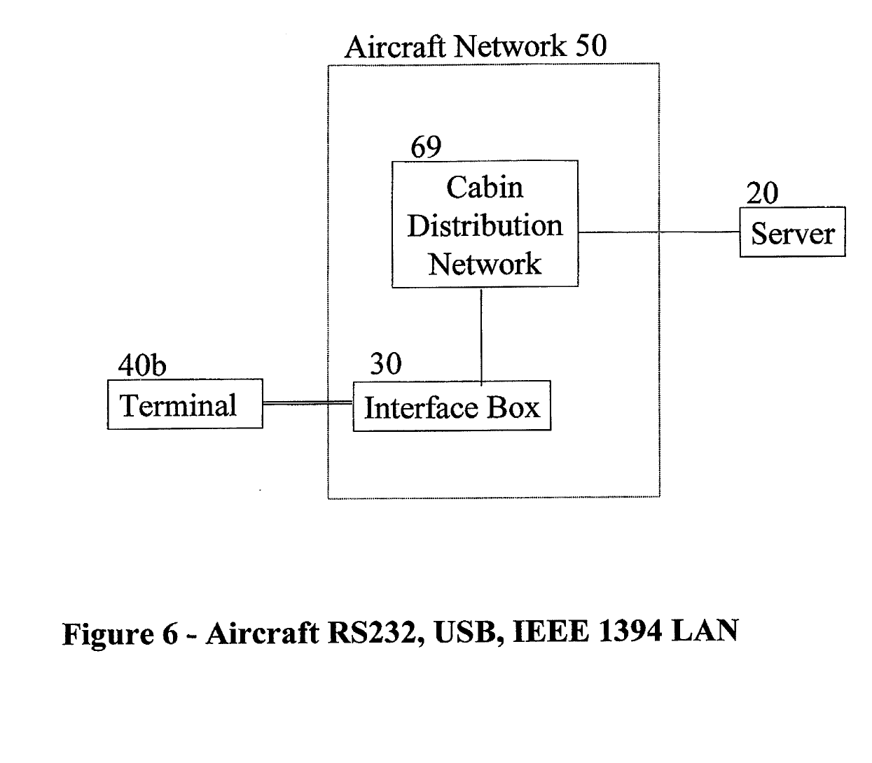

An alternative interface is an RS-232 port, which is illustrated in FIG. 6. Such an interface is available on many passenger terminals 40 and can provide data rates as high as 115 kbps. Accordingly, the aircraft network 50 shown in FIG. 6 provides a node 30 which allows the passenger to connect their RS-232 port from their seat. The node 30 is connected to a dedicated Cabin Distribution Network 69, which provides a communications path to server 20. The passenger terminal 40b is configured to utilize the serial port and establishes a PPP connection with server 20.

Some passenger terminals will support a USB connection, with data rates as high 12 Mbps. The aircraft network 50 shown in FIG. 6 provides a node 30, which allows the passenger to connect their USB port from their seat. The node 30 is connected to a dedicated Cabin Distribution Network 69, which provides a communications path to server 20. The passenger terminal 40b is configured to utilize the USB port and establishes a PPP connection with server 20.

Some passenger terminals will support an IEEE 1394 connection, with data rates as high 400 Mbps. The aircraft network 50 shown in FIG. 6 provides a node 30, which allows the passenger to connect their IEEE 1394 port from their seat. The node 30 is connected to a dedicated Cabin Distribution Network 69, which provides a communications path to server 20. The passenger terminal 40b is configured to utilize the IEEE 1394 port and establishes a PPP connection with server 20.

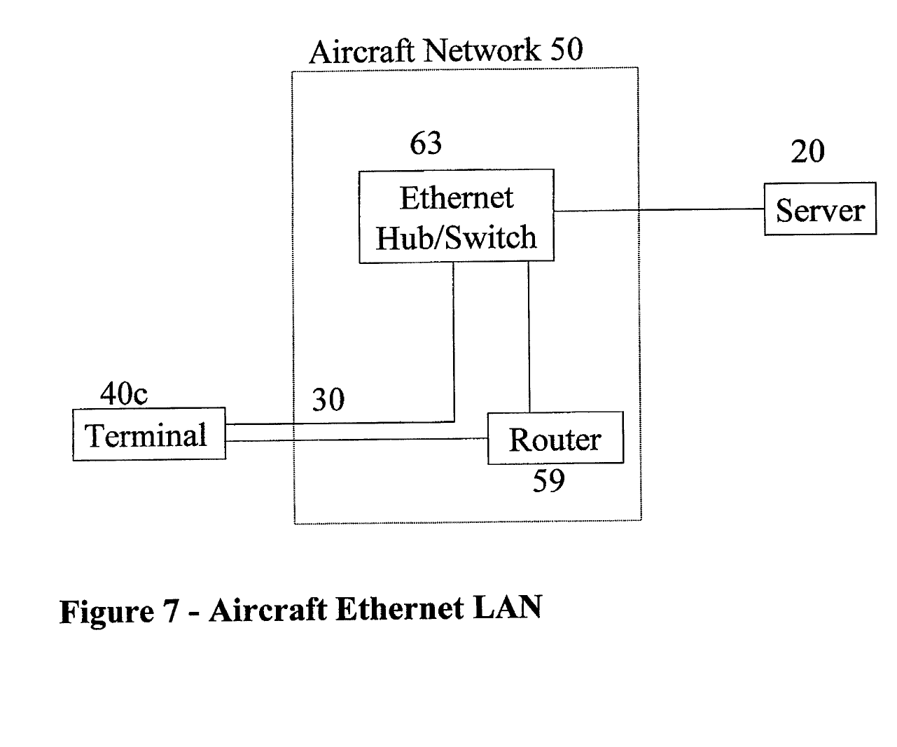

Some passenger terminals will support an Ethernet interface, with data rates as high as 100 Mbps. The passenger terminal can be connected to the aircraft network as shown in FIG. 7. Typically, the node 30 on the Ethernet interface uses an RJ45 jack connected into an Ethernet Hub/Switch 63. The Hub(s)/Switch 63 provide native IP networking services between the passenger terminal 40c and the server 20. This aircraft network is well known to one familiar in the art. In one embodiment, a router 59 is provided between the passenger terminal 40 and the Ethernet Hub/Switch 65 to allow use of a passenger terminal 40c fixed IP address and the server 20 assigned IP address.

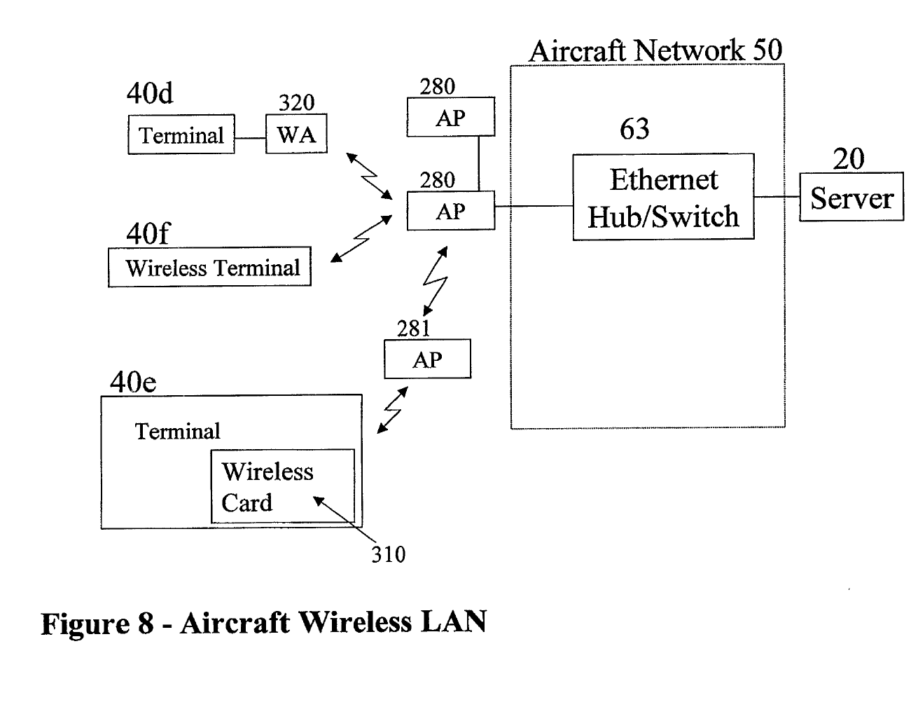

As shown in FIG. 8, some passenger terminals 40 will have a wireless capability. The aircraft network 50 provides connections to one or more access point AP 280 and optionally one or more access point AP 281. AP 280 is a wireless access point that generally is connected to aircraft network 50 using a network communication link, such as 802.3 Ethernet. In one instance AP 280 is directly connected to aircraft network 50. In an alternate instance, one AP 280 is connected to another AP 280, which is in turn connected to aircraft network 50.

AP 281 is a wireless access point that is connected to aircraft network 50 using a wireless connection to another AP 281 or AP 280. This provides flexible mounting options, as only power needs to be provided.

Terminal 40d is connected to a wireless access WA 320 using a wired connection, such as USB. WA 320 may be powered by terminal 40d USB, as described above with respect to FIGS. 3 and 4. WA 320 provides a network connection between terminal 40d and access point AP280. WA 320 may be specially qualified to be safely used onboard aircraft.

Terminal 40e includes a wireless network adaptor card 310. Card 310 provides a network connection between terminal 40e and AP281. Care must be taken to ensure card 310 is qualified to be safely used onboard aircraft.

Terminal 40f is a wireless terminal that directly communicates with AP 280. Care must be taken to ensure terminal 40f is qualified to be safely used onboard aircraft.

The specific wireless protocol implemented by the wireless LAN illustrated in FIG. 8 depends on the type of terminal 40 and type of interface used by the system. Those skilled in the art will appreciate that a number of well-defined protocols may be used to implement the wireless LAN of FIG. 8. Wireless protocols utilized include IR, Bluetooth, 802.11 and it's variants, cellular protocols such as GPRS, and proprietary wireless standards, for example used in two-way pagers.

The present invention permits essentially seamless roaming using a multitude of wireless devices that would otherwise be incompatible. As will be described in greater detail below, the proxy operation of the present invention allows disparate computing devices, such as pagers, cell phones, and laptop computers, each having its own communication protocol, to operate essentially in a normal manner. The system permits the end user (e.g., the passenger) to operate the device in a normal fashion despite being on an aircraft or in some other location where normal service is unavailable. A PPP or PPPOE connection is made between each passenger's terminal (e.g., the terminal 40b) and server 20 or between the wireless card 310 inserted in the passenger's terminal (e.g., the terminal 40e) and AP 280. When a passenger wishes to connect to node 30 from their terminal 40b, the cable 290 is used. When a passenger wishes to connect their terminal 40d, 40e, or 40f to aircraft network 50, wireless card 310 and AP 280 are used. When a passenger wishes to connect their terminal 40d, 40e, or 40f to wireless card 310, no cable is necessary because card is inserted directly into portable computer. In one embodiment, one end of cable 290 is inserted into the serial RS-232 port of the terminal, and the other end thereof is plugged into the socket in the armrest 230. In other embodiments other cabling and connector combinations are utilized, such as connections to the Universal Serial Bus, or the PC modem. In any event, at this point, a hardware connection has been made between the terminal 40a, 40b, 40c and aircraft network 50. In another embodiment, a wireless connection has been made between the individual terminal 40d, 40e, 40f and aircraft network 50.

The software requirements for connecting to server 20 will now be described. It will be understood that the system is designed to permit access by many different types of terminals, such as a “laptop” personal computer, a palm-top computer (PDA) running the Microsoft® Windows CE operating system, the Apple® Newton notebook or any other portable device including cellular telephones and two-way pagers, and the term “remote computer terminal” is to be construed accordingly. It will also be appreciated that this term is also intended to encompass any electronic device which is capable of PPP or PPPOE communication, which may include a fixed terminal on the aircraft, for example a part of the in-flight entertainment equipment. The desirability of allowing different platforms to connect to the server 20 is why a PPP or PPPOE connection between the computer and the server is preferred. PPP and PPPOE connections allow Point-to-Point Protocol (PPP) transmissions between the remote computer terminal (e.g., the terminal 40) and server 20, PPP not being limited to carrying TCP/IP traffic and being capable of piggy-backing other network protocols such as IPX, SPX and AppleTalk. The data may be communicated between the server 20 and the terminal 40 using one or more of: GSM, GPRS, IEEE 802.3 Ethernet, IEEE 802.11b, standard telephony modems such as V.90, USB, and other emerging and proprietary communication protocols. Over IP (Internet Protocol) networks, applications such as SSL (Secure Socket Layer), SMTP (Simple Mail Transfer Protocol); HTTP (Hypertext transfer protocol); POP3 (Post office protocol); IMAP (Internet Message Access Protocol), WAP, and XML may be used.

In an exemplary embodiment, installer software is provided to each user of the system. In a typical implementation, the installer software is obtainable from one or more of the following sources: pre-flight access to an Internet site; preflight e-mail; floppy disk; or any other suitable means. Typically different installer software will be required for use with different operating systems. In use, the installer software is executed by the passenger either during or prior to the flight. The software adds a new PPP service. The details of how such a PPP service is added will vary between different operating systems, but will be familiar to those skilled in the art. In circumstances where the installer software is provided in-flight, the software, once loaded into the passenger's terminal, changes the dial-up networking settings as required and starts the PPP service. It will be appreciated that a user could manually carry out the setting up of a new PPP connection, instead of obtaining and running the installer software which automatically does this for the user.

Internet client applications such as HTML browsers and e-mail applications subsequently started by the passenger then obtain Internet services from server 20 over the PPP service.

After the passenger disembarks from the aircraft after their flight, the next time they attempt to connect to their ISP/corporate server via a standard Public Switched Telephone Network (PSTN) connection, for example, the relevant network settings are still available on their remote computer terminal (e.g., the terminal 40).

With the above software and hardware arrangement, a data rate up to the maximum speed of the aircraft network 50 connection to the terminal 40 is possible, with a very large number of separate connections to the server 20 being possible. In practice, of course, there are typically only 300 or so seats on an aircraft, and the server 20 therefore only ever needs a maximum number of connections corresponding to the number of seats on the aircraft. In an alternative implementation, the server 20 may have fewer connections than the number of seats on the aircraft with the expectation that not all passengers will utilize the service. Specific implementations may be determined by the airline and are well understood by those skilled in the art. In embodiments making use of modem, serial port, USB, IEEE 802.11, and IEEE 1394 the provided data rates are on the order of 56 kbps, 115.2 kbps, 12 Mbps, 11 Mbps, and 400 Mbps respectively. USB and wireless interface standards are being revised and much higher speeds are anticipated.

Furthermore, whilst the hardware and software connections between the server 20 and the terminal 40 have been described in terms of PPP connections, it will be understood that Ethernet connections are equally possible. Nonetheless, having understood the function of the software operating on the passenger's computer, the skilled person will have no difficulty in implementing a similar program for Ethernet connection between that computer and the server. In particular, the system registry settings of a passenger's computer (e.g., the terminal 40) will need to be changed for the duration of the flight to reflect the fact that the passenger's computer is to be connected to a DNS gateway different to that which the passenger would normally use, as well as the use of a server defined IP address. The settings can be adjusted automatically by the software, and then automatically reset when the flight terminates and the passenger shuts down his computer. In one configuration, the server 20 provides DHCP (Dynamic Host Configuration Protocol) services to assign IP parameters automatically on terminal 40 when interfacing directly over Ethernet.

The server 20, aircraft network 50 and access point AP 280 or AP 281 provide additional interfaces to support devices that communicate in other protocols, such as GPRS, or proprietary protocols such as Mobitex. These additional interfaces are customized such that the supported devices interact with the user is a manner familiar and comparable to services provided while on the ground.

The aircraft network 50 provides additional advantages. Passengers may communicate with one another using the network, or with airline crew to request assistance, for example.

The aircraft network 50 provides a means to interconnect aircraft system 130 to server 20 provides to provide a means to exchange flight data with the operator of the aircraft using Internet protocols. In one configuration, the flight data is sent encrypted inside a standard Internet email message. In another configuration, the server 20 provides an object-oriented XML-type interface allowing direct transmission of selected flight data parameters or reports.

The server 20 additionally acts as a local WWW site. In particular, the server 20 includes a large cache which contains versions of a variety of WWW sites. These are loaded into the cache either by remote connection, to be described below, or by physically replacing the cache whilst the aircraft is at an airport.

For the preferred server 20 described above, a cache containing a multitude of WWW pages can be stored, in addition to audio and video data, to replicate a virtual world wide web environment.

Differential Management of Proxy Cache (DMPC) may be used. This allows very large collections of WWW pages to be updated and deleted on the basis of the changes to the code (e.g., the HTML) within each page, without having to reload all of each page when updating the cache. When the cache is first loaded, DMPC also allows a predetermined number of levels, such as three, within a particular web site to be downloaded to the cache automatically. However, in other embodiments a different number of levels are downloaded. Where three layers are stored each separate site mirror stored in the cache on the server 20 contains the “home page,” the first layer of pages referred to in the home page, and the second layer of pages referred to in the first layer of pages.

DMPC, or other processes, also removes any HTML code from the WWW sites downloaded into the cache, where that code would otherwise attempt to generate a hyperlink to a site that does not exist on the cache. Thus, there is no possibility for a passenger browsing the pages within the cache on board the aircraft to visit Internet sites which have not been stored in the cache.

Although the passenger's computer is therefore only accessing a “virtual” worldwide web, consisting of the pages of information stored in the cache, the server provides the information in a standard WWW form. Thus, each passenger can use their normal web “browser” to access the information stored in the cache as if they were accessing the original web site itself. As an option, the cache may also contain a search engine to allow those pages of interest to a passenger to be located.

In one embodiment, the server provides a search engine that references the URL of any pages contained on the server. In the event that the exact page is not found the search engine will conduct additional searching of the other URLs to determine whether there are any that appear similar in meaning to that one requested. Once obtained, the results of the search are provided to the passenger for viewing. Results of searches that are not matched may be used for updating the cache.

As previously mentioned, the cache can be updated in two different ways. The quickest method is for the cache to be updated directly from a cache drive which is brought on board the aircraft. At major airports, a Terrestrial Control Unit or TCU will be available for updating web-site content on a server. At any particular time, a TCU will contain updated web content for the sites that are contained on the server. When an aircraft arrives at a particular airport, updating the web cache simply involves transferring the updated information from the TCU to the server on an aircraft via an appropriate medium. The server 20 is switched on and a physical connection is made between the cache drive containing the data for updating and the cache within the server. Preferably, the updating takes place via DMPC. The physical connection can include physical replacement of the cache, connection to a data loader, or via a direct connection to an airport LAN.

An alternative method of updating the cache is from the TCU closest to the arrival airport. In this embodiment this is achieved by updating from the TCU via a wireless local area network (LAN) once the aircraft has landed. Some airports now have LANs which allow connection via wireless link such as “Gatelink” and high speed LAN link cable. Thus, as the aircraft arrives at the airport, the server can be configured to connect via this link to the airport LAN. Once a connection between the server 20 on board the aircraft and the LAN hub has been established, the latter can connect in turn to the closest TCU to obtain updates for the cache within the server on board the aircraft. As with the method of updating using a cache drive, the cache is updated using DMPC to minimize updating time.

Those skilled in the art will recognize that other links, such as use of the cellular phone or other public wireless data network, are possible to update the cache while the aircraft is on the ground. The server 20 may be configured to utilize these links as required. Alternatively, the cache may be updated during the flight if sufficient bandwidth is available on the radio links coupling the aircraft to the communications networks 80 (see FIG. 1).

In some embodiments, the server 20 is also configured to provide audio and video images to the passengers. Currently, some aircraft provide a screen (in the back of the seat in front of the passenger), and audio sockets in that passenger's armrest. A relatively small selection of audio and/or video programs is selectable by the passenger. Using the present system, provided that a passenger has a terminal with audio/video capabilities, then a very large quantity of audio/video entertainment can be provided. The very high data transfer rate possible on board the aircraft, when data does not have to be received from the ground, and the large amount of storage space on the server, permits, for example, MPEG movies to be viewed or games to be played.

The connection between server 20 and station 90 is best illustrated in FIG. 1 and will now be described in more detail. As passengers upon the aircraft compose and send messages, those messages are passed to server 20 which stores them. Simultaneously, messages sent from outside the aircraft and intended for passengers on board that aircraft accrue in a memory within the station 90.

The transmission is carried between the server 20 and the station 90 using standard protocols (TCP/IP/PPP) or other optimized protocols. The protocol has been developed to address the problems with wireless connections between the server 20 on board the aircraft, and the station 90 including rapid setup, reliable connections, full-duplex communications, and efficient recovery from failed connections. The data is transferred in a compressed form.

Server 20 controls the connection to the station 90. At, for example 15-minute intervals, the server 20 connects to the station 90. The server 20 provides the station 90 with a session I.D. and the number of blocks it is about to transfer together with the size of these blocks. Simultaneously, the station 90 confirms with server 20 the number and size of blocks to be transferred. The block size determined by server 20 may be overruled by the station 90, which determines the speed and reliability of the link.

Once confirmation is given, server 20 transfers block #1 to the station 90. If this transfer is successful the base station responds with an OK signal. This process continues until all blocks have been sent, or the connection fails or times out. This same process takes place for sending data from the station 90 to the server 20. In one embodiment, communication between server 20 and station 90 occurs simultaneously in both directions. If the data stream is broken, the server 20 restores the connection from the next block after the last block successfully acknowledged as received was sent.

The communications link remains active until the server 20 has delivered each of the messages waiting to station 90, and station 90 has also delivered each of its stored e-mail messages to server 20. When the server 20 detects that the data transfers are complete, it terminates the communications session with the station 90. In one configuration, the server 20 holds the communications session open for a predetermined period of time after all transfers are completed to allow for a response to a request made in the communications session, for example, to receive user authentication when sending down user log-on credentials. From that point, any messages received at server 20 from the passengers' terminals are stored in the cache of server 20 until the next connection to the base station is made. Similarly, messages at station 90 are stored there until the next connection. Those skilled in the art will recognize that the station 90 does not have to know in advance which passengers will log on to the server 20. Thus, the first communication between the server 20 and the station 90 may not result in email for passengers being transmitted from the station to the server. In one configuration, the server 20 and station 90 maintain a communications channel until messages are retrieved upon initial contact. In subsequent communications between the server 20 and the station 90, email messages will be retrieved via the proxy server in the manner described herein.

In one configuration, the passenger provides advance notification that they will be flying on a particular flight on a particular day between particular cities. Server 20 can connect to station 90 after the airplane is loaded with passengers. Station 90 can correlate the flight number to server 20 through interfaces to aircraft system 130 and reported by server 20, or by connecting to well established flight information services provided to the operator of the aircraft. An example of a well established flight information service is ACARS (Aircraft Communication, Addressing, and Reporting System). In one configuration, server 20 retrieves the initial messages for the passenger while waiting for takeoff using a lower cost communications service provider 80 or 81, such as a cellular phone network, rather than the communications service provider 80 or 81 used with the aircraft in flight.

Although communications have been described as being connected intermittently, it will be appreciated that other communications, specifically packet communications, which enable the server 20 and station 90 to communicate without circuit setup, will become available.

In addition to transferring message data, the communications links (when connected) also transfers web site updates during the flight. Because of the relatively low bandwidth of the existing communications links (e.g., the wireless link between the radios 60 and the communications networks 80 or 81 of FIG. 1), large scale updating of web pages stored in the cache on server 20 is not practical. Small amounts of information, perhaps relating to share prices of stocks, weather updates and breaking news stories can be provided. Such information updates can also be exchanged each time a connection is made to exchange messages.

Station 90 is arranged to connect to the message servers 195 and 192, and the content servers 185, of the various passengers on board the aircraft. Typically, a normal Internet connection 160 from VPN 150, as will be familiar to those skilled in the art, is used. In some cases, a special connection to a Communications Service Provider Network 81 is necessary to reach servers only available via that network connection. An example may be a connection to a cellular telephone network or two-way pager network. The base station may communicate with the server via a link selected from one or a combination of: one or more wireless links; and one or more wire links. In an exemplary embodiment, the base station communicates with the server via one or more wireless links, each of those wireless links being selected from the group comprising: a satellite link (Inmarsat or other provider); a cellular telephone link (GSM, CDPD, GPRS, or other); a wireless LAN link (IEEE 802.11b or other); a NATS compatible link (Verizon, AT&T or other); a proprietary communications link (pager networks, Mobitex, or other), and another communication system. The selection of each link may be dependent upon one or more of: the availability of each link; the relative cost of each link; and the relative speed of each link. The data may be exchanged between the ISP or corporate mail server and the base station using one or more of: SSL, SMTP; HTTP; POP3; IMAP, WAP, XML.

Certain mail servers may be accessed via a secure connection. Secure connections include a virtual private network over the Internet 160, or a private network reachable only via telephone dial-up connections. In these cases, station 90 connects directly to these mail servers, typically using whatever secure networking is available and when access is approved.

Messages sent to the passengers on board the aircraft will, of course, initially be sent to the mailbox at the passenger's ISP/corporate message server. The system described above fetches the message from the mailbox at the passenger's message server and forwards it to the passenger's terminal on the aircraft via station 90 and server 20.

Messages sent from the aircraft will travel first to the station 90, before proceeding on to their destination. In some cases, station 90 will send the message to the destination message server 195 or 192 directly. In other cases, station 90 will route send messages via the passenger's ISP/corporate mail server 195 which will in-turn send messages to their destination message server 195 or 192.

As shown in FIG. 1, station 90 connects via VPN 150 to web content processor 190 for the purposes of updating the web cache in server 20. Once the updated pages are stored at station 90, they are either transferred via communications network 80 or 81 to server 20, or manually transferred directly to server 20 when the aircraft is on the ground using one or more of the techniques described above, alone or in combination.

In another embodiment of the invention more than one base station is used for the intelligent management of e-mail information between an aircraft and the Internet. For example, FIG. 1 illustrates base station 90 and base station 120. Each base station is identical in specification and also the information they hold. This enables the aircraft to connect to any base station and find the pertinent information for the aircraft ready for retrieval. Each base station has connections to VPN 150, providing a means for receiving connections from any airborne server 20, communicate with other base stations, web content processors 190, and links to the Internet for retrieving/sending customers' information.

The method by which messages are sent from passenger's terminals on the aircraft to their destination, and the method of receipt of messages by the passengers' terminals on the aircraft from their respective message or content servers, will now be described.

Server 20 is configured to provide proxy Internet and messaging services to the terminals 40. For example, an HTTP request from a passenger's terminal (e.g., the terminal 40) for an HTML page is received by server 20, which recovers the requested HTML page, if available, from its cache. The HTML page is sent to the passenger's terminal which need not be aware that the page has not been sent directly from the remote WWW site. Similarly, the server 20 responds to IMAP, POP3 or SMTP requests from a passenger's terminal 40 as if it were the passenger's normal message server 195. Thus, the proxy configuration of the server 20 means that the passenger's terminal appears to be connecting directly to remote Internet or messaging services. The passenger informs the server 20 of their message server address, user id, password, and firewall details; this information may be automatically downloaded from the passenger's terminal 40 to the server 20 the first time the passenger's terminal attempts to retrieve messages without any additional or unique action on the part of the passenger.

In one embodiment, the base station is able to communicate with a corporate server that is behind a firewall. The corporate subscriber can provide firewall static user id and password once when signing up for service, arrange for VPN 150 to have secure access behind the corporate firewall, or the corporate subscriber can provide dynamic user id and password information the first time requesting file retrieval.

There is a very high bandwidth connection possible between each passenger's terminal 40 and server 20, and a potentially high bandwidth between station 90 and its eventual destination message server 195 or content server 185. The bandwidth of the radio connection between server 20 and station 90 is typically much slower and far more expensive to utilize.

The well-known SMTP protocol was developed for slow but permanent connections between machines on networks. The connection between server 20 and station 90 is, in contrast, both slow and non-permanent. An important feature of the system is that the connection time is relatively short, to minimize communications costs. During a short connection time, it is important to recognize that the negotiation or hand-shaking protocols and so forth will take up a relatively large percentage of the total connection time.

A method called Intelligent Mail Management (IMM) is used to manage the collection and delivery of messages including the management of any attachments to the messages. The IMM protocol analyses messages to identify the various components of the message. For example, if a message includes text and two attachments, the first having a size of 4 MBytes and the second having a size of 6 MBytes, station 90 describes each part to server 20. It may be, of course, impractical to send these very large attachments via the slow communications links between the server 20 and station 90. IMM sends a summary of the message received at the station 90 from the passenger's message server 195 or 192 to the server 20 on board the aircraft. Once this has been received by server 20, it is forwarded to the specified passenger, again using either the HTTP protocol, the POP3 protocol or any other suitable protocol, which may be selected based on the particular embodiment of the terminal 40 (e.g., a laptop computer versus a wireless email device).

When a passenger receives a message using this system, they receive an indication of any attachments to the original message. These attachments are only sent to the passenger on board the aircraft upon the passenger agreeing to pay for their delivery. In one embodiment, the passenger interacts with server 20 by utilizing a hyperlink in the received message leading to a private interactive web page hosted by server 20, providing an on-line means for the passenger to control the delivery of attachments. Alternatively, the passenger can defer delivery of large attachments until the passenger has left the aircraft and established an alternative connection to the relevant message server 195 or 192. As another alternate, the passenger may agree to pre-authorize retrieval of any message smaller than a configurable threshold.

A potential problem arises when a passenger logs onto server 20, thus triggering the system to collect any waiting messages from their mailbox at the message server 195 or 192, but does not retrieve some messages subsequently collected by base station 90 and stored in server 20 before leaving the flight. Copies of messages retrieved by station 90 will be retained at the originating message server 195 or 192; they are not deleted when retrieved by station 90. After the flight, the passenger will connect to the originating message server 195 or 192 through whatever means, and these messages will still available for download.

Some terminals 40 are configured to delete messages from the message server 195 once received. Server 20 informs station 90 which messages have been delivered to terminals and the terminal have issued a deletion command. At that point, station 90 will contact message server 195 and delete the appropriate messages. When a message has been retrieved in part, for example by not retrieving a large attachment, server 20 or station 90 keep the deletion command from terminal 40 to reach message server 195, thus allowing terminal 40 to retrieve the message in it's entirety once the passenger is on the ground and off the aircraft. Alternatively, the server 20 may inform station 90 that an email message has been read so that the status of the message may be appropriately altered at the message server (e.g., the message server (95).

In one embodiment, a message that is not delivered to the passenger is resent to or retained by station 90 and then subsequently resent to the passenger. Base station 90 can format the resent message to appear virtually identical to the original message.

Server 20 and base station 90 coordinate the registration of passengers such that messages are retrieved optimally for the duration of a flight. By monitoring aircraft system parameters such as passenger doors open/closed and whether the aircraft is airborne or on the ground, server 20 determines the appropriate time for base station 90 to cease retrieval of messages for that set of passengers on that particular flight. Base station 90 incorporates additional monitors to recover from the loss of communications with a particular server 20. The additional monitors include comparing status as communicated by server 20 with status from well established flight information services such as ACARS. The failure of server 20 to contact station 90 in a timely manner can be automatically detected by receipt of ACARS reports, such as at takeoff and landing, that are expected to be coupled with similar messages from server 20. Server 20 can detect unusual events, such as canceling a flight without leaving the gate, return to gate without taking off, and holding short of the destination gate for extended periods of time, and provide the optimum level of service for the particular situation. For example, message retrieval from base station 90 may cease when the airplane lands.

POP3 and IMAP are Internet standards for transferring messages from mailboxes at customer message servers 195 to the customer's terminal 40. The details of these protocols will be well known to those skilled in the art, and further details may be found in the request for comment (RFCs) for each of those protocols. While POP3 is acceptable for passing the messages to station 90, it has several limitations which make it less desirable for transfer of information between station 90 and the server 20. Specifically, POP3 does not allow message descriptions, and attachments to e-mail messages (such as graphic images and the like) are simply sent as encrypted, uncompressed text messages. The attachments can therefore be extremely large and on a standard dial-up connection between a terminal and an message server, with a transfer speed of 28.8 kbits per second, data transfer can take several minutes.

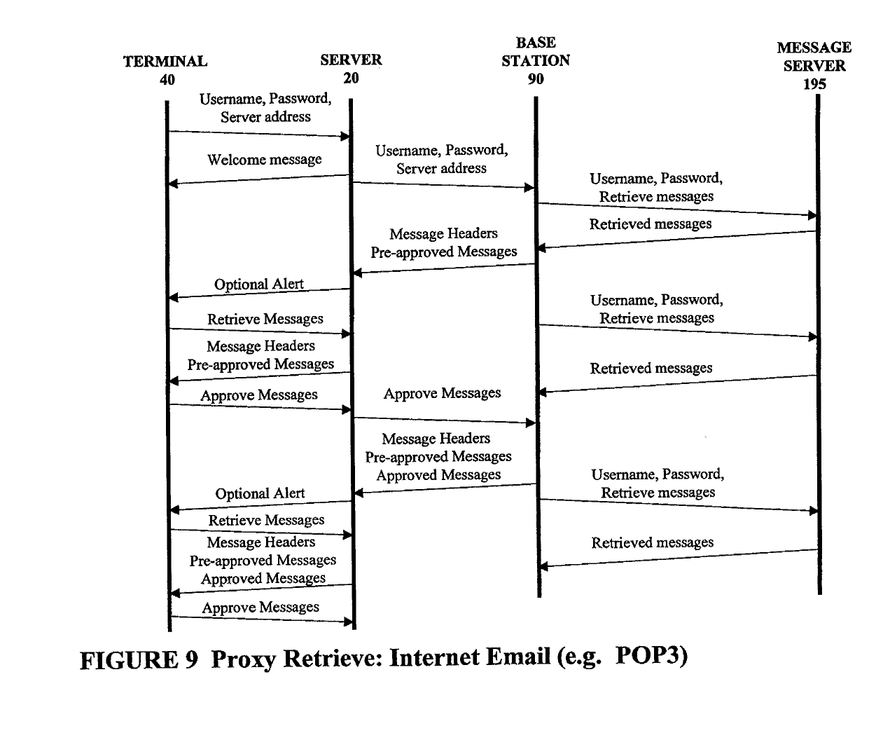

Referring now to FIG. 9, a method by which messages can be received from a passenger's message server (e.g., the message server 195 of FIG. 1) to their terminal on board the aircraft is shown. The terminal 40 may request Internet mail retrieval by configuration of an HTML web application provided by sever 20, or through a “native” client resident inside terminal 40. In the case of the HTML web application, the passenger must enter the message server address, their mailbox username and password directly through an HTML web form. Once this information is entered, server 20 may write the information into a cookie stored locally by the passenger's terminal to enable quickly re-activating the account settings on another, subsequent flight. In the case of a native client, the terminal 40 application will automatically provide this information to server 20 upon the passenger requesting to check for received mail. In an alternative configuration, this information is stored by station 90 and activated whenever the passenger requests service.

Upon receipt of the message server address, username and password, server 20 immediately responds as the targeted message server and produces a welcome message. This is viewed either through the native client or HTML web application inbox. It should be noted that no communication has yet occurred between server 20 and station 90.

At a subsequent time, server 20 contacts base station 90 and passes it the server address, username and password. Base station 90 contacts the requested message server and provides the passenger username and password and retrieves messages. Base station 90 then prepares summary information (e.g., headers) for server 20 indicating what messages are awaiting retrieval, as well as preparing any messages that qualify for pre-approval, per the requirements set by the passenger in the manner described above. Server 20 may wait for station 90 to respond, or when server 20 subsequently contacts base station 90, the headers and the pre-approved messages are retrieved. Server 20 may optionally raise an alert to gain passenger attention to terminal 40. The passenger may then retrieve any approved messages, and approve messages still on the ground. This process is repeated throughout the flight.

Those skilled in the art will recognize that the message flow illustrated in the example protocols of FIGS. 9-16 represent basic message flow. However, certain messages may be deleted without affecting the overall operation of the invention. Other messages, such as call setup and tear-down messages, have been omitted for the sake of brevity. FIGS. 9-16 illustrate a simple sample protocol used for message transmission and retrieval. Those skilled in the art will recognize that other exemplary protocols may be used that fall within the scope of the present invention.

It should be noted that the message flow between terminal 40 and server 20 approximates the normal message flow that would occur between the terminal and the message server (e.g., the message server 195 of FIG. 1) if the terminal were operating in its normal environment. Similarly, the message flow between station 90 and the message server 195 also approximates the normal message flow that would occur between the terminal 40 and the message server if the terminal were operating in its normal environment. However, the quantity of messages flowing between the server 20 and station 90 are minimized in order to reduce the traffic flow on the relatively bandwidth limited wireless connection between the aircraft and the communication service provider networks 80 or 81 (see FIG. 1). Thus, the proxy operation of the present invention allows the end user (i.e., the passenger) to utilize the terminal 40 in the normal manner such that, from all external appearances, the terminal is coupled directly to the message server 195. Similarly, the proxy operation of the present invention allows the message server 195 to communicate in a manner as if the message server 195 were coupled to the terminal 40 in a conventional fashion.

Base station 90 checks message server 195 periodically for new messages using the saved username and password of the passenger. At the end of the flight, when appropriate, server 20 sends a signal to base station 90 to cease retrieval of messages and to discard all sensitive data.

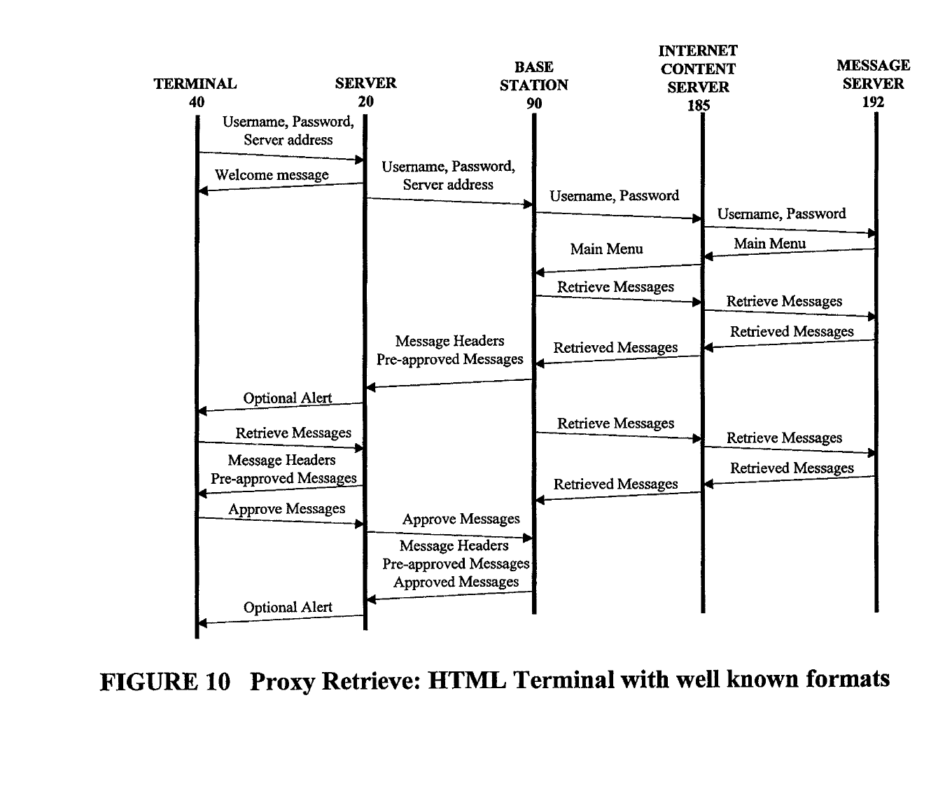

Some message servers are accessible via HTML web pages. In some cases, such as Microsoft Exchange 5.5, the format of these web pages can be predicted. Referring to FIG. 10, server 20 includes an HTML web application that requests the passenger to enter their message server address, username and password for specific servers, such as Microsoft Exchange 5.5. Server 20 passes this information to station 90.

In response to the receipt of passenger information, Station 90 logs into the Content Server 185 specified by the passenger. Content Server 185 retrieves the passenger's messages from message server 192. Station 90 retrieves the messages from the content server 185 by taking advantage of customized scripts optimized for the specific web page layout provided by the content server 185. In effect, base station 90 interacts with content server 185 in a manner indistinguishable from the passenger interacting directly with the content server 185 over a direct Internet connection.

Station 90 prepares summary information (e.g., headers) prepared for retrieved messages and prepares any messages pre-approved for delivery. Server 20 subsequently contacts base station 90 and retrieves the summary information and approved messages.

Passenger terminal 40 is optionally alerted and approved messages are retrieved. In addition, the passenger reviews the summary information for messages left at the base station and prepares approval for those selected for in-flight retrieval.

The process is repeated, with base station 90 retrieving messages from content server 185 periodically, and without requiring the user to re-enter their information. Again, it should be noted that the relative volume of message flow between the terminal 40 and server 20, and between the base station 90, Internet server 185 and message server 192 are all relatively large compared with the message volume between server 20 and station 90. As previously discussed, the bandwidth between the terminal 40 and server 20 is relatively large. Similarly, the connection between the station 90 and Internet content server 185, and the connection between the content server and the message server 192 are relatively high bandwidth connections. Thus, the proxy operation allows the passenger to operate the terminal 40 as if it were directly connected to the Internet content server 185. Similarly, the Internet content server 185 acts in a manner consistent with a connection to the terminal 40. However, the proxy operation of the present invention permits a relatively low volume of traffic through what is commonly accepted as the communication bottleneck (i.e., the wireless connection between the aircraft and the communication service provider networks 80 or 81 of FIG. 1).

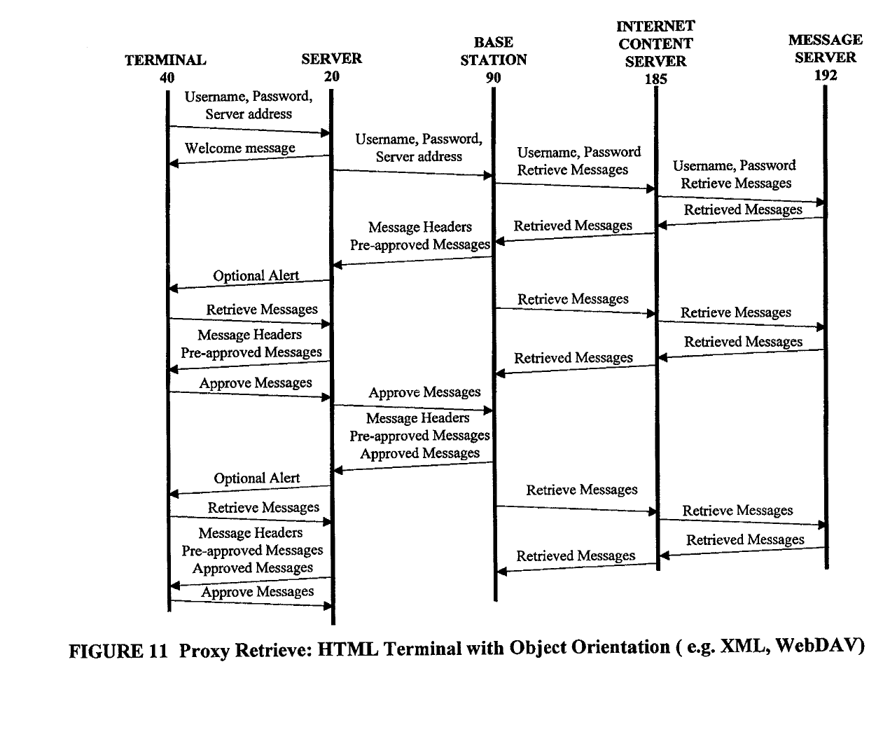

Some messages are accessible directly via HTTP, such as when using XML or WebDAV. Referring to FIG. 11, server 20 includes an HTML web application that requests the passenger to enter their message server address, username and password for this type of retrieval, such as for Microsoft Exchange 2000. Server 20 passes this information to station 90.

In response to receipt of the log-on information, station 90 logs the passenger into their Content Server 185 and requests received messages from the message server 192. Content Server 185 retrieves the passenger's messages from message server 192 and delivers them to base station 90. In effect, base station 90 interacts with content server 185 in a manner indistinguishable from the passenger interacting directly with the content server 185 over a direct Internet connection.

Station 90 prepares summary information prepared for retrieved messages and prepares any messages pre-approved for delivery. Server 20 subsequently contacts base station 90 and retrieves the summary information and approved messages.

Passenger terminal 40 is optionally alerted and approved messages are retrieved. In addition, the passenger reviews the summary information for messages left at the base station and prepares approval for those selected for in-flight retrieval.

The process is repeated, with base station 90 retrieving messages from content server 185 periodically, and without requiring the user to re-enter their information.

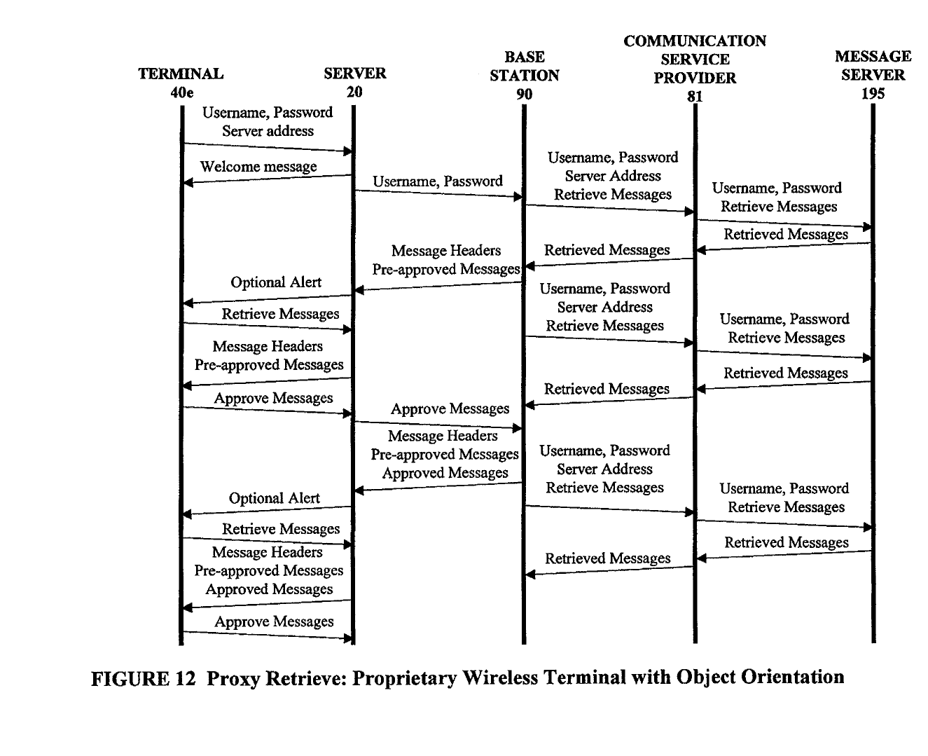

Some messages may only be retrieved via access through a proprietary communications service provider 81, such as Mobitex as used with RIM Blackberry pagers. As illustrated in FIG. 12, server 20 includes an HTML web application that requests the passenger to enter their message server address (optional), username and password for this type of retrieval. Server 20 passes this information to station 90. In some cases, station 90 will only be able to reach the communications service provider through a radio 61 interface. In an alternative configuration, the server 20 use a proprietary protocol to interface with terminal 40, including automatically retrieving passenger information and exchanging messages or other useful information.

In response to the receipt of information from the passenger, station 90 logs the passenger into the passenger message server 195 or the passenger content server 185 and requests received messages from the message server 195 or 192. Content Server 185 or message server 195 retrieves the passenger's messages from message server 195 or 192 and delivers them to base station 90. In effect, base station 90 interacts with content server 185 or message server 195 in a manner indistinguishable from the passenger interacting directly with the content server 185 or message server 195.

Base station 90 prepares summary information prepared for retrieved messages and prepares any messages pre-approved for delivery. Server 20 subsequently contacts base station 90 and retrieves the summary information and approved messages.

Passenger terminal 40 is optionally alerted and approved messages are retrieved. In addition, the passenger reviews the summary information for messages left at the base station and prepares approval for those selected for in-flight retrieval.

The process is repeated, with base station 90 retrieving messages from content server 185 or message server 195 periodically, and without requiring the user to re-enter their information.

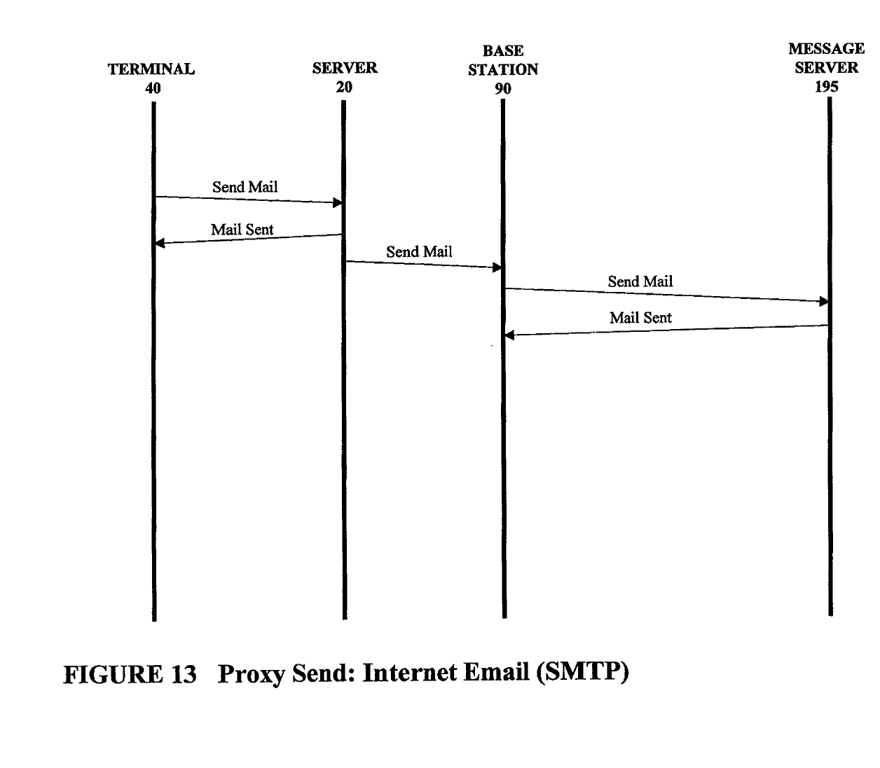

A messaging protocol for transmitting messages from the terminal 40 is illustrated in the diagram of FIG. 13. Terminal 40 connects to server 20 via the aircraft network 50 in any of the manners described above. Terminal 40 sends Internet messages and server 20 accepts the send messages masquerading as the send messages server 195. Server 20 periodically contacts base station 90 and transfers the send mail to base station 90. Base station 90 sends the mail using it's own SMTP server, delivering the message to the destination message server (e.g., the message server 195 of FIG. 1), and receives indication whether the message server 195 accepts the sent message.

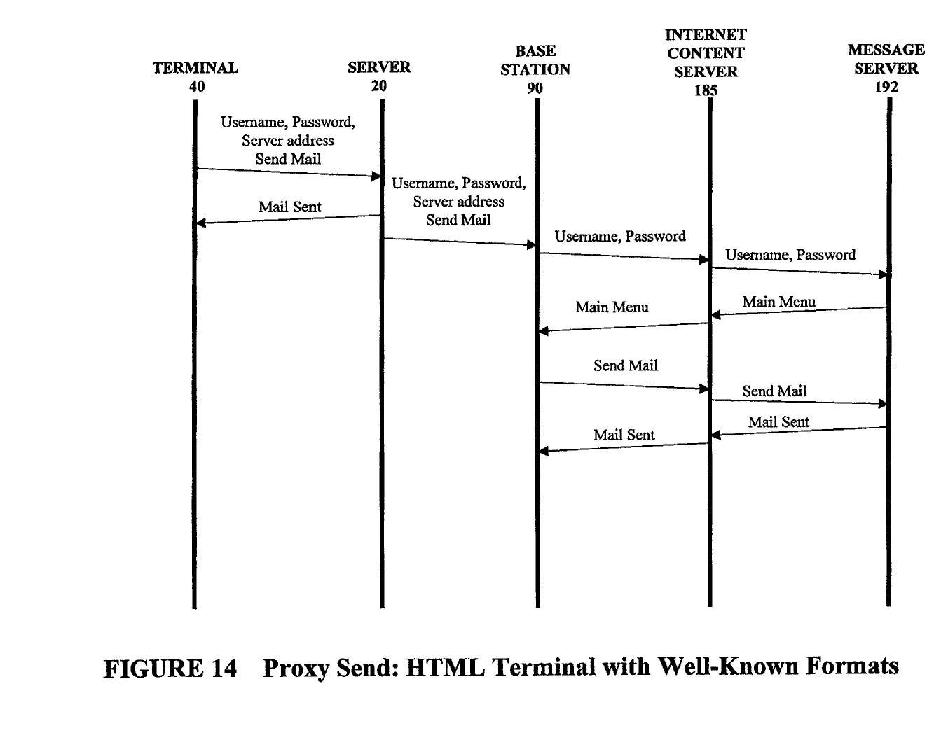

As illustrated in FIG. 14, server 20 provides an HTML web application to terminal 40 and requests the passenger enter their message server address, username, and password. Server 20 then provides a web-based client to compose messages. The passenger composes a message and approves it to be sent.

Server 20 sends a confirmation message to the terminal 40 and transfers the message, username, password, and message server address to base station 90. Base station 90 logs into the passenger's Content Server 185. Base station 90 sends the messages to the content server 185 by taking advantage of customized scripts optimized for the specific web page layout provided by the content server 185. In effect, base station 90 interacts with content server 185 in a manner indistinguishable from the passenger interacting directly with the content server 185 over a direct Internet connection.

Since the messages are sent via the content server 185 and message server 192, they are retained by the message server 192 as if they were sent directly, and any outgoing message have the appropriate taglines inserted by the proper message server 192.

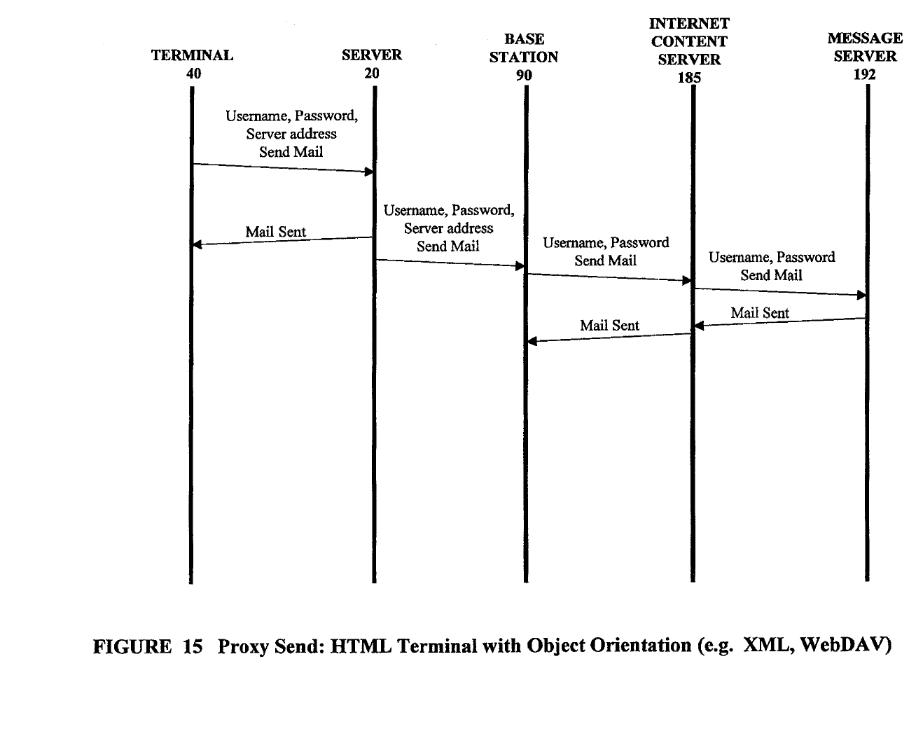

FIG. 15 illustrates a proxy send with an HTML terminal and object orientation, such as XML or WebDAV. Server 20 provides an HTML web application to terminal 40 and requests the passenger enter their message server address, username, and password. Server 20 then provides a web-based client to compose messages. The passenger composes a message and approves it to be sent.

Server 20 sends a confirmation message to the terminal 40 and transfers the message, username, password, and message server address to base station 90. Base station 90 logs into the passenger's Content Server 185 and sends the message. Base station 90 interacts with content server 185 in a manner indistinguishable from the passenger interacting directly with the content server 185 over a direct Internet connection.

Since the message are sent via the content server 185 and message server 192, they are retained by the message server 192 as if they were sent directly, and any outgoing message have the appropriate taglines inserted by the proper message server 192.

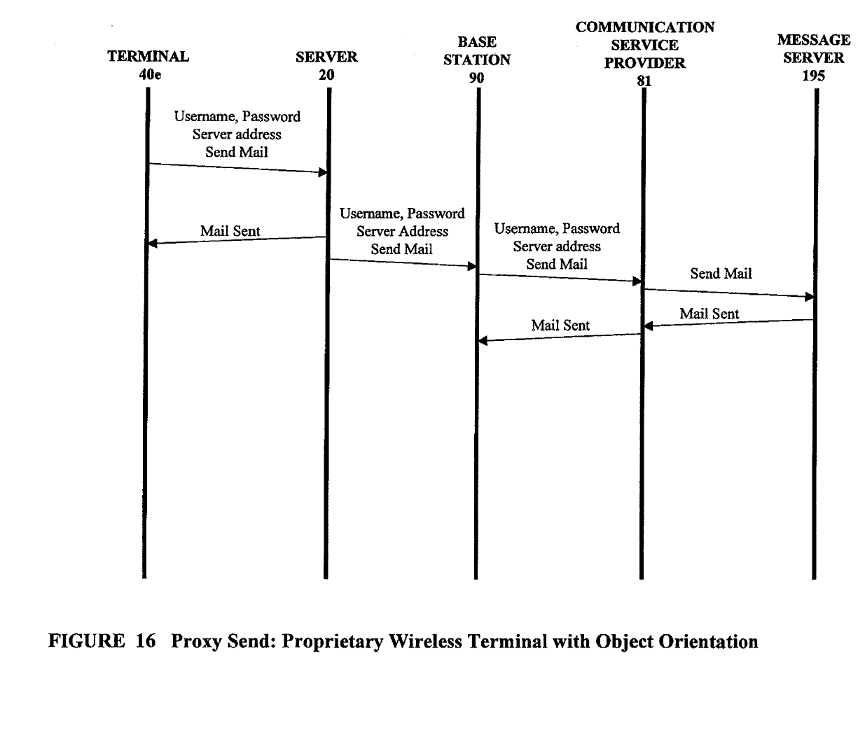

FIG. 16 illustrates a proxy send with a proprietary wireless terminal with object orientation. Server 20 provides an HTML web application to wireless terminal 40 and requests the passenger enter their message server address, username, and password. Server 20 then provides a web-based client to compose messages. The passenger composes a message and approves it to be sent. In some cases, the wireless terminal will only use it's own precoded applications or protocols. In other cases, the wireless terminal will provide a generic, browser interface, such as a WAP page.

Server 20 sends a confirmation message to the terminal 40 and transfers the server address, message, username, password, and message server address to base station 90. Base station 90 logs into the communications service provider 81 and sends the message. Base station 90 interacts with communications service provider 81 in a manner indistinguishable from the passenger interacting directly on the ground.

Since the message is sent via the communications service provider 81 and message server 195 or 192, they are retained by the message server 195 or 192 as if they were sent directly, and any outgoing message have the appropriate taglines inserted by the proper message server 195 or 192.

As previously discussed, the system includes a single base station 90 and can include a number of base stations 120 located at spaced apart locations on the surface of the planet.

Returning to the system of FIG. 1, as the aircraft flies from its departure airport towards the destination airport, aircraft system 130 indicates to server 20 the location of the aircraft at regular intervals.

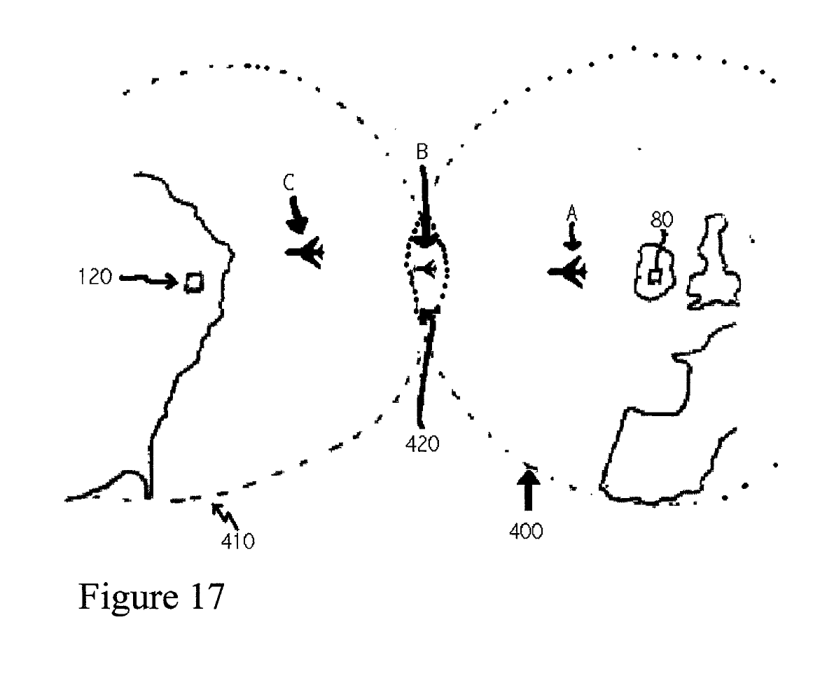

Another embodiment of the invention is illustrated in FIG. 17. More particularly, in this embodiment, use is made of a plurality of spaced apart base stations. For ease of illustration only a second base station 120 is shown. In other embodiments more than three base stations are used. The base stations are functionally equivalent, but may be implemented using different conventional hardware components in a manner that is known to the skilled in the art, and which need not be described in greater detail herein.

Rather than communicating with any one of the base stations, server 20 communicates with that base station to which it is closest to at the time. The technique by which the aircraft connects to a base station, and in particular how hand-over between a first base station 90 and a second base station 120 takes place, will now be described in more detail with reference to FIG. 17. The planet is divided up into regions or cells 400, 410 with a region of overlap 420 between them. FIG. 17 only shows two such base stations 90, 120 and their respective cells 400, 410. However, in practice, a number of base stations will be provided around the planet at suitable locations. For example, base stations may be provided in Western Europe, North America, South America, South East Asia, Southern Africa and Australia. The size of each cell will, of course, depend upon the total number of base stations provided, so that the main airline routes are covered. In one exemplary embodiment of the invention only three base stations are utilized, one in the UK, one in the USA, and one in Australia.

An aircraft flying from London to New York will connect over the initial part of its flight to the first base station 90 located, for example, in the Republic of Ireland. Station 90 is used when the aircraft is stationary at the point of embarkation. While the aircraft is being cleaned and refueled, the wireless connection to communications service provider 80 or 81 is made, or the cache drive is supplied, to update the cache within server 20. Once the aircraft leaves the airport in London, all communications are made via communications service provider networks 80 or 81 to base station 90. At position A shown in FIG. 17, for example, the aircraft is still within the first cell 400 and communicates solely with station 90. The aircraft is able to track its own position using aircraft system 130. Each time the aircraft connects to station 90, in addition to exchanging data carrying messages and cache updates, it also informs station 90 of its position.

Each base station is pre-programmed with its coverage area. When the aircraft enters the transition area 420 between two cells, station 90 commands server 20 to contact station 120 for subsequent connections. Station 90 then contacts station 120 via VPN 150 and provides the necessary information for station 120 to continue to provide service.

The aircraft initiates communications and continues to communicate with station 120, which now carries out the various functions previously carried by station 90, such as downloading information from various Internet sites so that the cache in server 20 can be updated, and connecting to the passenger's message server to retrieve messages. The second base station 120 may provide different information to the first base station 90. For example, when the cache is updated during the flight, news, weather and so forth for the geographical area surrounding station 120 may be provided instead. Passengers traveling from London to New York may accordingly receive both up-to-date and relevant information throughout the flight.

Under some circumstances, it is possible server 20 will inadvertently contact the wrong base station. While server 20 should retain necessary information in non volatile memory to recover gracefully from a reset condition, all base stations will respond to server 20 with the necessary information to contact the correct base station, using VPN 150. In one embodiment, certain passenger configuration information is retained at the base station to enable server 20 to recover from a reset condition without interrupting service or necessitating all passengers re-register for service.

The various protocols referred to in this specification, unless otherwise indicated, are all industry standards. Full details of these standards may be obtained from various sources as will be known by those skilled in the art. It will be appreciated that these protocols undergo continuous development and evolution, and new protocols emerge as well. While protocols have been identified explicitly, it will be appreciated that other protocols can be utilized.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “b elow,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other media delivery systems, not necessarily for the audio and text delivery system described above. The elements and acts of the various embodiments described above can be combined to provide further embodiments.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A wireless computer communication system for use with passenger computing devices while onboard an aircraft, comprising:
an access point positioned aboard the aircraft to permit wireless communication with the passenger computing device of at least one passenger;
an airborne server on the aircraft communicatively coupled to the access point;
a wireless adaptor positioned aboard the aircraft for connection with the passenger computing device of the passenger, the wireless adaptor comprising a transmitter portion and a receiver portion to establish a wireless communication link between the wireless adaptor and the access point and thereby permit communication between the passenger computing device and the airborne server.

2. The system of claim 1 wherein the wireless adaptor comprises an input connector configured to be coupled to the passenger computing device by an interface cable, the connector being further configured to provide electrical power to the wireless adaptor from the passenger computing device via the interface cable whereby the wireless adaptor derives power solely from the passenger computing device.

3. The system of claim 1 wherein the wireless adaptor comprises a universal serial bus (USB) input connector configured to be coupled to the passenger computing device by a USB interface cable, the USB connector being further configured to provide electrical power to the wireless adaptor from the passenger computing device via the USB interface cable whereby the wireless' adaptor draws power solely from the passenger computing device.

4. The system of claim 1 wherein the wireless adaptor comprises a serial bus input connector configured to be coupled to the passenger computing device by a serial interface cable, the serial connector being further configured to provide electrical power to the wireless adaptor from the passenger computing device via the serial interface cable whereby the wireless adaptor draws power solely from the passenger computing device.

5. The system of claim 1 wherein the wireless adaptor comprises an IEEE 1394 input connector configured to be coupled to the passenger computing device by an IEEE 1394 interface cable, the IEEE 1394 connector being further configured to provide electrical power to the wireless adaptor from the passenger computing device via the IEEE 1394 interface cable whereby the wireless adaptor draws power solely from the passenger computing device.

6. The system of claim 1 wherein the wireless adaptor comprises an Ethernet input connector configured to be coupled to the passenger computing device by an Ethernet interface cable, the Ethernet connector being further configured to provide electrical power to the wireless adaptor from the passenger computing device via the Ethernet interface cable whereby the wireless adaptor draws power solely from the passenger computing device.

7. The system of claim 1 wherein the at least one passenger is seated in one of a plurality of rows of seats, the wireless adaptor being positioned in a seat back of the row of seats in front of the passenger.

8. The system of claim 1, further comprising a protective housing to at least partially enclose the wireless adaptor to permit the wireless adaptor to be positioned at a passenger selected position.

9. The system of claim 1 wherein the at least one passenger is seated in one of a plurality of rows of seats having seat arms, the wireless adaptor being positioned in a seat arm of the passenger seat.

10. The system of claim 1 for use with a plurality of passengers seated in a rows of seats, the wireless adaptor having a plurality of input connectors being positioned proximate the row of seats for use by the plurality of passengers.

11. A wireless computer communication system for use with passenger computing devices while onboard an aircraft, comprising:
an airborne server on the aircraft;
an access point communicatively coupled to the airborne server; and
wireless means for connecting the passenger computing device of at least one passenger with the access point to thereby permit wireless communication between the passenger computing device and the airborne server.

12. The system of claim 11 wherein the wireless means comprises transmitter and receiver means for establishing a wireless communication link between the wireless adaptor and the access point.

13. The system of claim 11 wherein the wireless means comprises an input connector configured to be coupled to the passenger computing device by an interface cable, the connector being further configured to provide electrical power to the wireless means from the passenger computing device via the interface cable whereby the wireless means derives power solely from the passenger computing device.

14. The system of claim 11 wherein the at least one passenger is seated in one of a plurality of rows of seats, the wireless means comprising a circuit board positioned in a seat back of the row of seats in front of the passenger.

15. The system of claim 11, further comprising a protective housing to at least partially enclose the wireless means to permit the wireless means to be positioned at a passenger selected position.

16. The system of claim 11 wherein the at least one passenger is seated in one of a plurality of rows of seats having seat arms, the wireless means comprising a circuit board positioned in a seat arm of the passenger seat.

17. The system of claim 11 for use with a plurality of passengers seated in a rows of seats, the wireless means comprising a circuit board having a plurality of input connectors being positioned proximate the row of seats for use by the plurality of passengers.

18. A method of wireless computer communication for use with passenger computing devices while onboard an aircraft, comprising:
operating an airborne server on the aircraft;
providing an access point communicatively coupled to the airborne server; and
connecting the passenger computing device of at least one passenger with the access point using a wireless communication link to thereby permit wireless communication between the passenger computing device and the airborne server.

19. The method of claim 18 wherein connecting the computing device with the access point comprises transmitting data to the access point and receiving data from the access point to thereby establish a wireless communication link between the passenger computing device and the access point.

20. The method of claim 18 wherein connecting the computing device with the access point comprises coupling an interface cable from the passenger computing device to an input connector of a wireless interface, the connector being further configured to provide electrical power to the wireless interface from the passenger computing device via the interface cable.

21. The method of claim 18 wherein the at least one passenger is seated in one of a plurality of rows of seats and connecting the computing device with the access point comprises positioning a wireless interface in a seat back of the row of seats in front of the passenger.

22. The method of claim 18, further comprising distributing the wireless interface to the passenger in a protective housing to at least partially enclose the wireless interface to permit the wireless interface to be positioned at a passenger selected position.

23. The method of claim 18 wherein the at least one passenger is seated in one of a plurality of rows of seats having seat arms and connecting the computing device with the access point comprises positioning a wireless interface in a seat arm of the row of seats.

24. The method of claim 18 for use with a plurality of passengers seated in a rows of seats wherein connecting the computing device of each of the plurality of passengers with the access point comprises positioning a wireless interface having a plurality of input connectors proximate the row of seats for use by the plurality of passengers.

25. A wireless electronic messaging system for use in an aircraft to permit electronic message communication between a passenger electronic messaging device operated by a passenger and a ground-based electronic messaging system via a wireless communication link, comprising:
an airborne computing system;
an access point positioned aboard the aircraft and coupled to the airborne computing system to permit communication with the passenger messaging device and thereby form a computer network; and
a proxy server coupled to the computer network to emulate the response of the ground-based electronic messaging system with respect to the passenger messaging device whereby the passenger messaging device interacts with the proxy server in a manner consistent with the interaction between the passenger messaging device and the ground-based electronic messaging system when the passenger messaging device is not on the aircraft.

26. The system of claim 25 wherein the passenger messaging device is a device selected from a group of messaging devices comprising a personal computer, personal digital assistant, paging device and wireless telephone.

27. The system of claim 25 for use with a airline supplied computing device installed on-board the aircraft proximate the passenger seat wherein the wireless messaging device is the computing device and exchanges passenger messages with the passenger ground-based electronic messaging system.

28. The system of claim 27 wherein the computing device is coupled to the computer network and receives multimedia data therefrom.

29. The system of claim 25 wherein the proxy server receives, and transmits to the ground-based electronic messaging system, mail server addresses, user identification and password, including applicable firewall access information when the passenger initially attempts to send or retrieve messages.

30. The system of claim 29 wherein the user identification comprises a dynamic password, the proxy server transmitting the dynamic password to the ground-based electronic messaging system.

31. The system of claim 25 wherein the proxy server provides installer software for selective loading to the passenger messaging device, wherein the installer software automatically changes access settings of the passenger messaging device for accessing and exchanging messages with the proxy server over the computer network, and automatically returns the access settings to a prior condition upon termination of the flight.

32. The system of claim 25 wherein the passenger has provided passenger identification information regarding the ground-based electronic messaging system to a ground-based computer system prior to a flight, the proxy server establishing a communication link with the ground-based computer system to retrieve the passenger identification information.

33. The system of claim 32 wherein the proxy server establishes a communication link with ground-based electronic messaging system prior to flight departure to retrieve messages from the ground-based electronic messaging system intended for the passenger.

34. The system of claim 33 wherein the communication link with ground-based electronic messaging system is established using a public wireless data network.

35. The system of claim 25 wherein the proxy server is configured to compress the message before transmission over the wireless communication link.

36. The system of claim 25, further comprising a base station to communicate with the aircraft while in flight, the base station communicatively coupled to a ground-based proxy server to communicate with the ground-based electronic messaging system, the ground-based proxy server emulating the response of the passenger messaging device with respect to the ground-based electronic messaging system whereby the ground-based electronic messaging system interacts with the ground-based proxy server in a manner consistent with the interaction between the passenger messaging device and the ground-based electronic messaging system when the passenger messaging device is not on the aircraft.

37. The system of claim 36 wherein the proxy server receives passenger identification information regarding the ground-based electronic messaging system to enable initial retrieval of messages from the ground-based electronic messaging system intended for the passenger, the proxy server establishing a communication link with the ground-based electronic messaging system via the ground-based proxy server to retrieve messages from the ground-based electronic messaging system intended for the passenger.

38. The system of claim 37 wherein the passenger identification information comprises firewall access information, the ground-based proxy server using the passenger identification information to communicate with the ground-based electronic messaging system via a virtual private network to thereby establish a secure link

39. The system of claim 36 wherein the proxy server periodically establishes a communication link with the ground-based electronic messaging system via the ground-based proxy server after the initial retrieval to automatically check for messages intended for the passenger without any additional requests for message retrieval from the passenger.

40. The system of claim 36 wherein the ground-based proxy server is configured to compress message intended for the passenger before transmission over the wireless communication link.

41. The system of claim 40 wherein the message compression comprises transmitting only text message data over the wireless communication link.

42. The system of claim 36 wherein the proxy server communicates with the ground-based electronic messaging system via the ground-based proxy server to delete the messages that have been received by the passenger messaging device.

43. The system of claim 42 wherein a message has only been partially received by the passenger messaging device and the proxy server communicates with the ground-based electronic messaging system via the ground-based proxy server to indicate that the partially received messages have not been read and to prevent the deletion thereof.

44. The system of claim 36 wherein a message has only been partially received by the passenger messaging device and the proxy server communicates with the ground-based electronic messaging system via the ground-based proxy server to indicate that the partially received messages have not been read.

45. The system of claim 36 wherein the communication link established between the computer network on the aircraft and the base station is maintained for a predetermined period of time following the completion of transmissions of messages to and from the passenger to permit the ground-based proxy server to retrieve additional messages intended for the passenger.

47. The system of claim 25, further comprising a cabin telecommunications unit (CTU) to control communications between the passenger messaging device and the proxy server, the CTU also controlling communication between the proxy server and a radio with which the aircrtaft communicates with a terrestrial base station.

48. A wireless electronic messaging system for electronic message communication between a passenger electronic messaging device operated by a passenger onboard an aircraft and a ground-based electronic messaging system via a wireless communication link, comprising:
a base station to communicate with the passenger messaging device; and
a ground-based proxy server communicatively coupled to the base station to communicate with the ground-based electronic messaging system, the ground-based proxy server emulating the response of the passenger messaging device with respect to the ground-based electronic messaging system whereby the ground-based electronic messaging system interacts with the ground-based proxy server in a manner consistent with the interaction between the passenger messaging device and the ground-based electronic messaging system when the passenger messaging device is not on the aircraft.

49. The system of claim 48 wherein the ground-based proxy server receives passenger identification information regarding the ground-based electronic messaging system to enable initial retrieval of messages from the ground-based electronic messaging system intended for the passenger, the ground-based proxy server stablishing a communication link with the ground-based electronic messaging system to retrieve messages from the ground-based electronic messaging system intended for the passenger.

50. The system of claim 49 wherein the passenger identification information comprises firewall access information, the ground-based proxy server using the passenger identification information to communicate with the ground-based electronic messaging system via a virtual private network to thereby establish a secure link

51. The system of claim 36 wherein the aircraft generates aircraft-related data, the proxy server emulating an airline server to receive the aircraft-related data for transmission to the base station, the ground-based proxy server receiving the aircraft-related data and emulating the aircraft to forward the aircraft-related data to the airline.

52. The system of claim 51 wherein the airline generates aircraft-related data, the ground-based proxy server emulating the aircraft to receive the aircraft-related data for transmission to the aircraft, the proxy server receiving the aircraft-related data and emulating an airline server to forward the aircraft-related data to the aircraft.

53. The system of claim 52 wherein the aircraft related data is transmitted to and from the aircraft as a message compliant with Internet standards.

54. A method of wireless electronic messaging for use in an aircraft to permit electronic message communication between a passenger electronic messaging device operated by a passenger and a ground-based electronic messaging system via a wireless communication link, comprising:
coupling the passenger messaging device to an airborne computing system to permit communication with the passenger messaging device and thereby form a computer network; and
emulating a response of the ground-based electronic messaging system with respect to the passenger messaging device whereby the passenger messaging device interacts with the airborne computing system in a manner consistent with the interaction between the passenger messaging device and the ground-based electronic messaging system when the passenger messaging device is not on the aircraft.

55. The method of claim 54 wherein the passenger messaging device is a device selected from a group of messaging devices comprising a personal computer, personal digital assistant, paging device and wireless telephone.

56. The method of claim 54 for use with a airline supplied computing device installed on-board the aircraft proximate the passenger seat wherein the wireless messaging device is the computing device and exchanges passenger messages with the passenger ground-based electronic messaging system.

57. The method of claim 54, further comprising receiving and transmitting to the ground-based electronic messaging system, mail server addresses, user identification and password, including applicable firewall access information when the passenger initially attempts to send or retrieve messages.

58. The method of claim 57 wherein the user identification comprises a dynamic password and transmitting comprises transmitting the dynamic password to the ground-based electronic messaging system.

59. The method of claim 54, further comprising installing installer software for selective loading to the passenger messaging device wherein the installer software automatically changes access settings of the passenger messaging device for accessing and exchanging messages over the computer network, and automatically returns the access settings to a prior condition upon termination of the flight.

60. The method of claim 54 wherein the passenger has provided passenger identification information regarding the ground-based electronic messaging system to a ground-based computer system prior to a flight, the method comprising establishing a communication link with the ground-based computer system to retrieve the passenger identification information.

61. The method of claim 60, further comprising establishing a communication link with ground-based electronic messaging system prior to flight departure to retrieve messages from the ground-based electronic messaging system intended for the passenger.

62. The method of claim 61 wherein the communication link with ground-based electronic messaging system is established using a public wireless data network.

63. The method of claim 54, further comprising compressing the message before transmission over the wireless communication link.

64. The method of claim 54, further comprising communicating with a ground-based computing device communicatively coupled to the ground-based electronic messaging system, the ground-based computing device emulating the response of the passenger messaging device with respect to the ground-based electronic messaging system whereby the ground-based electronic messaging system interacts with the ground-based computing device in a manner consistent with the interaction between the passenger messaging device and the ground-based electronic messaging system when the passenger messaging device is not on the aircraft.

65. The method of claim 64, further comprising receiving passenger identification information regarding the ground-based electronic messaging system to enable initial retrieval of messages from the ground-based electronic messaging system intended for the passenger, establishing a communication link with the ground-based electronic messaging system via the ground-based computing device to retrieve messages from the ground-based electronic messaging system intended for the passenger.

66. The method of claim 65 wherein the passenger identification information comprises firewall access information, the ground-based computing device using the passenger identification information to communicate with the ground-based electronic messaging system via a virtual private network to thereby establish a secure link

67. The method of claim 65, further comprising periodically establishing a communication link with the ground-based electronic messaging system via the ground-based computing device after the initial retrieval to automatically check for messages intended for the passenger without any additional requests for message retrieval from the passenger.

68. The method of claim 64, further comprising compressing message intended for the passenger before transmission over the wireless communication link.

69. The method of claim 68 wherein the message compression comprises transmitting only text message data over the wireless communication link.

70. The method of claim 54, further comprising communicating with the ground-based electronic messaging system to delete the messages that have been received by the passenger messaging device.

71. The method of claim 70 wherein a message has only been partially received by the passenger messaging device and the method comprises communicating with the ground-based electronic messaging system to indicate that the partially received messages have not been read and to prevent the deletion thereof.

72. The method of claim 54 wherein a message has only been partially received by the passenger messaging device, the method further comprising communicating with the ground-based electronic messaging system to indicate that the partially received messages have not been read.
